(19) United States
(12) Patent Application Publication
(10) Pub. No.: US 2012/0203678 A1
(43) Pub. Date: Aug. 9, 2012

(54) COMPUTER-ENABLED METHOD AND SYSTEM FOR AUTOMATED ALLOCATION AND DISTRIBUTION OF PROCEEDS FOR SALE OF VETERINARY PRODUCTS

(75) Inventors: DONALD C. SUTTER, TULSA, OK (US); KURT D. GREEN, PORTLAND, OR (US); THOMAS A. FRIAR, PORTLAND, OR (US); ANDREW J. BANE, PORTLAND, OR (US)

(73) Assignee: STRATEGIC PHARMACEUTICAL SOLUTIONS, INC., PORTLAND, OR (US)

(21) Appl. No.: 13/022,908

(22) Filed: Feb. 8, 2011

(51) Int. Cl. G06Q 10/00; G06Q 30/00

(52) U.S. Cl. 705/34

(57) ABSTRACT

A computer-enabled method and system for dynamic, automated pricing of veterinary pharmaceutical and other animal-related product items by a central product provider, wherein the method allows subsequent recovery of historical pricing information by the central product provider computer for subsequent sale proceeds sharing with a veterinary hospital, comprising the steps of: asynchronously creating and storing member account details, asynchronously retrieving from vendors and storing pricing and other information for a plurality of product item records, asynchronously maintaining and storing a plurality of per-product-item fee records and proceed split percentage information, providing to veterinary hospitals responsive item product information for one or more items selected and creating and temporarily storing a snapshot for subsequent optional recall of product item record pricing, per-item and per-invoice fee information, and making selected item product information available for display. Upon selection of a product item for purchase by a veterinary hospital or customer, a unique invoice record is created which comprises the temporarily stored per-item and per-invoice fee information corresponding to the product item, hospital and/or customer making the selection. Finally, the hospital and/or customer related per-item and per-invoice fee and price information is used, together with hospital and central product provider percentage split information, for automated determination, allocation, crediting and distribution of proceeds to the veterinary hospital based upon saved historic, granular pricing and fee data.

### BACKGROUND OF THE INVENTION

The present invention relates in general to pricing and proceeds allocation and distribution for the sale of veterinary pharmaceuticals and other animal-related products, and in particular to a computer-enabled method and system for automated, dynamic pricing and proceeds allocation and distribution for integrated point of sale and e-commerce sale of veterinary pharmaceuticals and other animal-related products.

Traditionally, pharmacy's within veterinary hospitals, and especially those within smaller animal treatment facilities or locations where only one or just a few licensed veterinarians have been authorized to do business, have struggled to profitably and effectively manage and dispense veterinary pharmaceuticals and animal supplements. This has been in part due to the lack of a system for effectively integrating work flow of animal pharmacies and animal care providers such as veterinarians and veterinary hospitals.

FIG. 1a illustrates the traditional method of pricing of veterinary pharmaceuticals and other animal related products sold by a hospital pharmacy 109, such as at a traditional veterinary hospital or other animal treatment facility where a licensed veterinarian is authorized to do business. Because there are such a large number of veterinary products that are constantly changing, it is difficult at best for an animal hospital to stay current and remain profitable while managing the large number of products necessary for different animal treatment conditions encountered. Maintaining inventory against becoming stale or otherwise outdated has been a challenge in such a situation.

Further, from a product pricing perspective, it has been challenging for individual hospital pharmacies 109 to maintain profitability while wholesale costs on a wide array of products have frequently varied and changed from time to time.

Referring to FIG. 1b, for these and other reasons there have developed centralized veterinary pharmacies 105 which have offered the advantage of having been better able than a smaller hospital pharmacy (as shown at 109 on FIG. 1a) to stay current and keep fresh stock. But these centralized pharmacies 105 have not adequately integrated the hospital or veterinarian in the loop of treatment of animals or profitability regarding the sale of veterinary products. Accordingly, there has been a disincentive in the more traditional centralized veterinary pharmacy system for animal hospitals to send customers to such centralized pharmacies, since animal hospitals have not been included in the profitability loop and have also reported concerns of losing customers and not being adequately involved in treatment of animals, since such centralized pharmacies have had more exclusive and direct contact with pet owners. Though some of this problem has been alleviated by legally requiring veterinarians to more frequently see the animals for which prescriptions are made, this doesn't address the lack of profit incentive for veterinarians to deal with traditional centralized pharmacies associated with prior art pricing systems. Ultimately, it has been understood that cutting veterinarians out of the animal treatment and profitability loops in animal care has been unwise and has not been good for the animals, their owners, veterinary hospitals or individual veterinarians.

Since there is currently a very large number of supplement and pharmaceutical treatment options available for animals presenting a wide variety of disorders and conditions, it has been very difficult, if not impossible, for a veterinarian, or a small veterinary hospital, to have maintained in stock sufficient quantities of each of the many and varied medications available, without such supplies becoming stale, losing potency, or expiring. Further, the management of such inventory, even if possible, would be very cumbersome, labor intensive, and expensive. This problem has been exacerbated by the fact that, with some medications or products, the number of animals for which the product may have been beneficially prescribed has been relatively small.

In short, these traditional methods of pricing and distributing proceeds have exhibited many shortfalls. Since the prior art method of pricing and proceeds allocation and distribution has not been dynamic or automated, there has been increased cost to the end-user because the pharmacy has had to increase the price of the product to protect against unforeseen interim wholesale price changes. This has been especially true where a large number of products have needed oversight. Or alternatively, prior art increase changes in wholesale pricing have negatively impacted profitability for the pharmacy.

Static retail pricing of veterinary pharmaceuticals and other animal products puts everyone in the veterinary product sale and delivery transaction at risk of loss from a wholesale price change, up or down as shown at A, B and C of FIGS. 1a and 1b. As shown at lines A, B and C, veterinary product vendors 101 frequently modify wholesale pricing, usually in the upward direction, as shown at 102, 103, 104 of FIGS. 1a and 110, 111, 112 of FIG. 1b. Further, as shown by the magnitude of Price at 106, 107 and 108 FIG. 1a, and 114, 115, 116, a static model of pricing, allocation and proceeds distribution does not readily accommodate changes in pricing by the vendor 101, or in the distribution chain. In the case of line C of FIG. 1a, the wholesale price 104 is greater than the retail price 108, and the hospital 109 is losing money on each sale of the product. Similarly, in the case of line C of FIG. 1b, the cost shown at 112 to the central product provider 105 is greater than the price to the customer at 116, causing the central product provider to lose money one each sale of the product. Again, to mitigate the losses the prices are many times higher at the customer level than they need to be to make sure in the supply chain that distributors don't get caught by interim price changes, whether they be wholesale product price changes or associated fee increases such as handling fees, shipping fees, credit card processing fees, taxes, pharmacy fees, nutrition fees and the like.

Veterinarians and veterinary hospitals have heretofore not had the time, technology, methods or processes to effectively participate in the transaction, since the means of tracking the myriad of products and their price and associated fee changes has proven daunting to say the least. To date, there hasn't been an effective, comprehensive, integrated and computerized system in place that would have been highly beneficial to pet owners and animals and that would have incentivized animal hospitals with profitability on pharmaceutical and other product sales. This has been due, in some part, to the fact that very large product development costs have not previously been able to have been spread over a larger number of customers, such that these large development costs have been prohibitive to making new products. However, now that economies of scale have been introduced into the system with addition of the concept of centralized pharmacies selling products to a much wider range of customers, and with the advent of computer database technology, a novel system and method of integrating animal hospitals, pharmacies and customers around product sales has been needed. Without such an integrated system, the products would have been too expensive to develop.

Since an effective product sales channel and associated system and method in which veterinary hospitals could participate profitably has been lacking, this has, in the end, naturally resulted in a more limited range of treatment options for animals. More particularly, the inability of prior art centralized pharmacies to more effectively control costs by putting tighter tolerances and granularity on price change strategies with a computer controlled, dynamic price modification system, in order to better facilitate integration of animal clinics into the product sales transaction loop, whether it be in a consumer direct or a hospital sale, has been an impediment to profitable participation by veterinarians in this aspect of animal treatment. And this, in turn, has led to less involvement of the veterinarian in treatment of animals, when ideally the veterinarian should be more involved rather than less.

Lesser involvement of veterinarians in treatment plans has been shown to negatively impact compliance by animal owners and others in administering recommended treatments to animals. Largely, such noncompliance has resulted from inherent delay and the inconvenience placed upon the owner to return to the veterinarian to renew prescriptions, to hand-carry prescriptions to the local pharmacy, wait to have them filled, and to remember to administer the treatment as prescribed to the animal according to the treatment plan. Thus, non-compliance may include any deviation from the treatment plan of the veterinarian, such as an owner's failure to renew the prescription, failure to refill the prescription and do so in a timely manner, or failure to administer the treatment and do so in a timely manner according to the treatment plan. Since the animal has been mostly unable to indicate need for treatment, compliance has been left primarily to the owner in this traditional scenario, and diminished compliance has resulted.

It is distressing that there has been a very low compliance rate in the administration of pharmaceuticals to animals, documented as between 34-48 percent among customers of veterinary preventative medications, and 19% for therapeutic diets, as published in the 2003 AAHA study, The Path to High-Quality Care: Practical Tips for Improving Compliance.

And this scenario of complication of appropriately computing accurate retail pricing, complication of determining regulatory compliance with taxing and other agencies and subsequent proceeds allocation and distribution to animal hospitals and centralized veterinary pharmacies has been exacerbated by the need for treatments that have involved the administration of multiple doses of medicine or supplement on a periodic basis, for example weekly, to the animal caretaker. As medicines and products have become more advanced, there has been an advantage associated with periodic dosing, and this has only complicated the transaction, requiring computerized facilitation of transactions.

Accordingly, there has been a need for a computer-enabled, dynamic pricing and proceeds allocation and distribution system for use with a centralized pharmacy for service to multiple, distributed animal treatment facilities and veterinarians. There has been a need for a system that is cooperative in nature, a system that supports a veterinary product distribution channel in which every participant involved has a high level of confidence in the system and every participant is incentivized to participate in the system.

Further, there has existed a need for removal of complicated and burdensome regulatory compliance from veterinarians and veterinary hospitals, while at the same time allowing for funding of regulatory agencies to provide consumer and animal protection roles. Prior art methods have effectively cut animal hospitals and veterinarians out of the loop because they have not had the profit incentive or the staff support to effectively comply with such regulatory and compliance requirements. And this, in turn, has negatively impacted the competitiveness of veterinary hospitals and served to limit the number of treatment options available to animal caretakers.

Likewise, the aforementioned impediments have led to a disincentive for research and development for increasingly better animal pharmaceuticals and products.

From an animal pharmacy's perspective, it has been difficult to integrate many disparate providers of animal care services with a standard product offering that is effectively managed, given the many different products available and the fact that the product list and pricing is constantly changing. Such difficulty has further acted to prevent involvement of individual veterinarians and animal hospitals in transactions involving the sale of veterinary pharmaceuticals and other animal-related products, since pharmacies have had only less effective means of marketing to and creating relationships with animal care providers. For example, prior methods of marketing animal pharmaceutical products to veterinarians have involved a system of advance sheets and traditional marketing literature provided to veterinarians and hospitals by drug sales representatives of drug manufacturers who have called on the veterinarians and hospitals.

Accordingly, it has been a challenge for veterinary hospitals and veterinarians to participate successfully in, and profit from the sale of, pharmaceutical and other animal-related products for treatment of animals seen at the veterinary hospital. And this, in turn, has negatively impacted the treatment of animals, since already low rates of compliance with veterinary treatment regimens overall are worsened where the veterinarian is not effectively involved, financially or otherwise, in the pharmaceutical and supplement dispensing and supplying process. This situation is complicated in the case of treatments that have involved the administration of multiple doses of medicine or supplement on a periodic basis, for example weekly, or daily for a period of time.

Prior non-computerized methods and systems of enabling, controlling and managing the processing, fulfilling, dispensing and handling of sales of animal-related products have not included a customizable, automated means of product offering, selection, pricing, billing, accounting and proceeds sharing capability to enable veterinarians and animal hospitals to effectively participate and profit from the sale directly to customers of the increasingly larger varieties of products available. As such, traditional prior art methods and systems of dispensing veterinary pharmaceuticals have not employed effective means for veterinarians and their staff to participate in the product sale transaction and thus more positively impact compliance of the animal owner in using the prescribed medication or supplement to support more effective treatment outcomes. Thus, in addition to the need for an effective and automated method of enabling customized product marketing, offerings and selection, as well as controlling sales and distribution of animal-related products, there has been needed an effective and automated method to include animal hospitals and veterinarians in the allocation and distribution of proceeds from sales of such products.

Prior attempts to address the basic limitations of manual ordering, fulfillment and dispensing of animal product systems, as with a typically customer-centric, centralized pharmacy accessible by the customer, or alternatively by the veterinarian, by telephone or the Internet, have not adequately involved the animal hospital, or veterinarian, in the process, either from a dispensing follow-up standpoint or from a financial standpoint. Thus, while such systems have enabled improvements, allowing greater ease for the animal owner to access the pharmacy via telephone or Internet, and hence they have improved the efficiency of fulfilling prescriptions, these systems have not effectively incentivized participation of the animal hospital and thus have limited the otherwise beneficial participation by the animal hospital in the transaction. And this ultimately has negatively impacted compliance with animal treatment plans.

Further, though with previously described methods and systems, sometimes a veterinarian has been able to call in, fax in, or email in a prescription directly to the central pharmacy for manual pickup by the customer, such solutions have lacked a coherent strategy and computerized system for marketing and offering both pharmaceutical and other animal-related products for automated pricing and selection by the animal care provider. Such a system is needed that is customizable by and for each animal care provider and that is easy to operate and determine retail prices while ultimately enabling the animal care provider to benefit from its efforts and be involved in this aspect of the ongoing treatment of the animal.

Such prior art telephone or Internet enabled systems have not been well designed to account for the fact that, in order for a veterinarian to issue a prescription, he or she must first see the animal for which the treatment plan is issued. Therefore, while the telephone or Internet enabled model of distributing veterinary pharmaceuticals has facilitated the distribution of medicines, it still has lacked a viable method for involvement of the veterinary hospital in the offering and selection of products and ultimately the creation of effective animal treatment plans by a veterinarian that is intimately familiar with the animal. Of course, with such prior art systems a veterinarian could call or fax a remote central pharmacy and place a medication order, based on a relatively incomplete system of advance sheets received by the hospital from drug manufacturers, and that order could be shipped to the customer directly by the central pharmacy, but this method has required additional steps for the veterinarian to send the prescription to a remote pharmacy and has lacked a comprehensive system for facilitating customizable product selection by the hospital and individual prescribing veterinarians. Such a system has been needed while managing and facilitating the process and relationship between the hospital and the pharmacy, all while fostering an economic incentive for the veterinarian and hospital to use a particular pharmacy.

In fact, such prior art systems may have introduced a disincentive for better hospital and pharmacy relationships, because once the customer has been introduced to the pharmacy with such prior art, centralized telephone and Internet pharmacy methods, the pharmacy may have developed, and frequently has developed, a direct relationship with the animal owner, selling additional products and services directly to the owner with no supervision and no economic benefit to the veterinarian. Thus, such systems have done little to improve the compliance of administering pharmaceuticals and supplements in accordance with a veterinarian-prescribed treatment plan, since in such case follow through with treatment has still been left almost exclusively to the animal owner.

While the foregoing clearinghouse-type centralized pharmacy solutions have sought to address the inability of veterinarians to effectively and profitably participate in long term treatment plans of animals, as described above, the solutions have entailed other problems, have not provided a comprehensive, yet customizable, means of presenting products for selection by a veterinarian, have not provided automated, dynamic pricing of products, have not addressed compliance issues as described, and have not adequately involved the veterinarian in the process or transaction, financially or otherwise, sufficient to ensure the high-quality treatment that owners expect for their pets and other animals.

### SUMMARY OF THE INVENTION

In accordance with a first aspect of the invention, a computer-enabled method for dynamic, automated pricing of veterinary pharmaceutical and other animal-related product items by a central product provider, wherein the method allows subsequent recovery of historical pricing information by the central product provider for subsequent sale proceeds sharing with a veterinary hospital, is provided. The method comprises the steps of: (a) in a central product provider computer, asynchronously creating and storing in a computer readable medium member account details for a veterinary hospital identified by a unique hospital ID; (b) in the central product provider computer, asynchronously maintaining and storing in a computer-readable medium a plurality of per-item fee records, each fee record comprising at least a unique per-item fee ID, a product item ID, a fee amount, a hospital ID, a pharmacy portion designation and a veterinary hospital portion designation; (c) in the central product provider computer, asynchronously retrieving and storing in a computer readable medium information for a plurality of product item records, each product item record being given at least a unique product item record ID and a current base price, each product item record being received from at least one networked vendor computer; (d) responsive to a request from a veterinary hospital computer, in a central product provider computer, creating in computer readable memory a temporary invoice record comprising a unique invoice ID, temporarily storing in the invoice record the veterinary hospital ID of the hospital making the request and providing to the veterinary hospital computer item product information for at least one item for selection; (e) responsive to a selection from the veterinary hospital computer, in the central product provider computer, temporarily storing in the invoice record a snapshot for subsequent optional recall of product item record information comprising at least a unique product item ID, current base price corresponding to the selected product item, at least one per-item fee corresponding to the selected product item, the at least one per-item fee comprising a fee ID and a per-item fee amount, and a selected product item price total comprising the sum of the product item current base price and the at least one per-item fee amount; and (f) making available for display at the veterinary hospital computer the selected item product information and the corresponding the total selected product item price.

In accordance with this aspect of the invention, the at least one per-item fee preferably comprises at least one of the following fees: handling fee, pharmacy fee, nutrition fee, item cover fee, wholesale sales tax and distribution fee. It will be appreciated by those of ordinary skill in the art that other fees may be included as per-item fees without departing from the true scope and spirit of the invention.

Further, in accordance with this aspect of the invention, the steps of the method are preferably repeated for each item product selected for inclusion on the invoice or order, the method creating an item record temporarily stored in the temporary invoice record for each iteration of the steps of the method. In this way, each item of the order includes its separate per-item fee which later aids in determining the proper allocation and distribution of sale proceeds.

In accordance with another aspect of the invention, the central product provider computer-readable medium further comprises storage for at least one per-invoice fee, each per-invoice fee comprising a per-invoice fee ID and a per-invoice fee amount, and the following additional steps are provided: (a) in the central product provider computer, responsive to a confirmation of an intention to purchase the at least one item temporarily stored in the temporary invoice record, retrieving and storing in the invoice record at least one per-invoice fee comprising a fee ID and an associated fee amount; (b) calculating and storing in the invoice record an invoice total comprising each product item price total and the at least one per-invoice fee; and (c) marking the invoice record as open and transferring the invoice record to an invoices database.

In accordance with this aspect of the invention, the unique hospital ID references a wallet database with at least one set of credit card processing information for the hospital, and the method further comprises the steps of processing payment of the invoice total using the at least one set of credit card processing information, obtaining approval from the credit card financial institution, marking the invoice as paid and releasing the order for fulfillment.

The at least one per-invoice fee in accordance with this aspect of the invention comprises at least one of the following fees: credit card processing fee, shipping fee and applicable federal, state and local taxes. It will be appreciated by those of ordinary skill in the art that other fees may be included as per-invoice fees without departing from the true scope and spirit of the invention.

Finally, in accordance with this aspect of the invention, it will be appreciated that the central product provider computer, as well as any of the vendor computers, may readily comprise a plurality of networked computers that jointly perform the same functions as a single computer, without departing from the true scope and spirit of the invention.

These first two aspects of the invention address the limitations of the aforementioned prior art manual pharmaceutical and animal product pricing systems, as well as telephone or Internet-based centralized animal pharmacies. Of course, since a centralized pharmacy is able to be effectively employed with the invention, the issues of large numbers of products, and specialty products which are not used by a very large number of animals, are greatly minimized. Inventory management is not such a problem with a larger, centralized pharmacy, and pricing and product information is more effectively transmitted to the hospital over the Internet.

Since each individual hospital's fee information is able to be stored and changed on the central pharmacy's server system, interim changes to the hospital's fees, whether they be per-product-item or per-invoice changes, the changes take place immediately in a central and coherent system overall such that all subsequent transactions for the hospital and customers of the hospital automatically reflect as price changes. This, in turn, adds to the ability of veterinary hospitals to more effectively manage and profit from the sale of veterinary products to their customers.

Since the system of the invention allows centralized marketing and hospital customization of product selection by hospital staff and animal owner customers associated with a large number of hospitals, enabling custom product offerings of automatically and dynamically priced products for sale, the invention effectively accommodates a large number of smaller, in many cases, and disparate veterinary treatment centers—effectively enabling them to provide veterinary pharmaceuticals and products directly to their customers.

In accordance with another aspect of the invention, a customer of the hospital is facilitated in making a purchase at a point of sale computer system at the hospital. In accordance with this aspect of the invention, there is provided a computer-enabled method for dynamic, automated pricing of veterinary pharmaceutical and other animal-related product items by a central product provider, wherein the method allows subsequent recovery of historical pricing information by the central product provider for subsequent sale proceeds sharing with a veterinary hospital. This aspect of the invention comprises the following steps: (a) in a central product provider computer, asynchronously creating and storing in a computer readable medium member account details for a veterinary hospital identified by a unique hospital ID; (b) in the central product provider computer, asynchronously maintaining and storing in a computer-readable medium a plurality of per-item fee records, each fee record comprising at least a unique per-item fee ID, a product item ID, a fee amount, a hospital ID, a pharmacy portion designation and a veterinary hospital portion designation; (c) in the central product provider computer, asynchronously retrieving and storing in a computer readable medium information for a plurality of product item records, each product item record being given at least a unique product item record ID and a current base price, each product item record being received from at least one networked vendor computer; (d) responsive to a request from a veterinary hospital computer, in a central product provider computer, creating in computer readable memory a temporary invoice record comprising a unique invoice ID, temporarily storing in the invoice record the veterinary hospital ID of the hospital making the request and providing to the veterinary hospital computer item product information for at least one item for selection; (e) responsive to a selection from the veterinary hospital computer, in the central product provider computer, temporarily storing in the invoice record a snapshot for subsequent optional recall of product item record information comprising at least a unique product item ID, current base price corresponding to the selected product item, at least one per-item fee corresponding to the selected product item, the at least one per-item fee comprising a fee ID and a per-item fee amount, and a selected product item price total comprising the sum of the product item current base price and the at least one per-item fee amount; and (f) making available for display at the veterinary hospital computer the selected item product information and the corresponding total selected product item price.

In accordance with this aspect of the invention, the at least one per-item fees preferably comprise one or more of the following: handling fee, pharmacy fee, nutrition fee, item cover fee, wholesale sales tax and distribution fee. Also, the steps of the method in accordance with this aspect of the invention are preferably repeated for each item product selected for inclusion on the invoice, the method creating an item record temporarily stored in the invoice record for each iteration of the steps of the method.

Further, in accordance with another aspect of the invention, the central product provider computer-readable medium further comprises storage for at least one per-invoice fee, each per-invoice fee comprising a per-invoice fee ID and a per-invoice fee amount, and the following additional steps are provided: (a) in the central product provider computer, asynchronously creating and storing in a computer readable medium member account details for a veterinary hospital customer identified by a unique customer ID; (b) in the central product provider computer, responsive to a confirmation of an intention to purchase the at least one item temporarily stored in the temporary invoice record, retrieving and storing in the invoice record at least one per-invoice fee comprising a fee ID and an associated fee amount; (c) calculating and storing in the invoice record an invoice total comprising each product item price total and the at least one per-invoice fee; and (d) marking the invoice as open and transferring the invoice record to an invoices database.

Still further, in accordance with this aspect of the invention, the unique customer ID references a wallet database with at least one set of credit card processing information for the customer. Further, there are provided the following additional steps: processing payment of the invoice total using the at least one set of credit card processing information, obtaining approval from the credit card financial institution, marking the invoice as paid and releasing the order for fulfillment.

In accordance with this aspect of the invention, the at least one per-invoice fee preferably comprises one or more of the following fees: credit card processing fee, shipping fee and applicable federal, state and local taxes. Also, the central product provider computer may comprise a plurality of networked computers without departing from the true scope and spirit of the invention. Further, the steps of the method of this aspect of the invention are repeated for each item product selected for inclusion on the invoice, the method creating an item record temporarily stored in the temporary invoice for each iteration of the steps of the method.

This aspect of the invention allows hospitals to readily provide for the sale of veterinary products and pharmaceuticals at computerized point of sale terminals as the veterinary hospital. The products made available to customers at such point of sale systems are dynamically and automatically appropriately priced in such a way that the hospital can receive appropriate credit for sold items according to pricing at the time of the sale. In this way the hospital is facilitated to participate in the transaction, and as such is encouraged in the involvement of ongoing treatment of the animal.

Further still, the steps of the method of this aspect of the invention may preferably further comprise the step of using the dynamic retail pricing information in a hospital client computer system wherein hospital staff may access appropriately priced products made available in prescription creation and point-of-sale services.

In this way, dynamically priced products may be made available to hospital staff to complete a sale transaction right at the hospital point-of-sale terminal (as shown in FIG. 1c), with product samples being made available to send home with the customer for their animal, and providing for delivery of the rest of the product directly to the customer's doorstep from the central fill pharmacy. Again this enables the hospital to effectively make available a very wide range of treatment options and products to customers and to participate in the transaction in a way that better ensures that the veterinarian will be consulted throughout the process and enabled to create and sell an effective treatment regimen to best address the needs of the animal.

Since the veterinary hospital is able to participate effectively in the transaction, it is incentivized to build and maintain a good relationship with the centralized pharmacy. This is not only good for business for each party involved, but this also results in more effective service to animal-owner customers, other animal care takers and their animals.

In accordance with another aspect of the invention, there is provided means for the central product provider to host a website for the hospital that is accessible by customers of the hospital to purchase products from the central product provider over the Internet via the hosted website. In accordance with this aspect of the invention, there is provided a computer-enabled method for dynamic, automated pricing of veterinary pharmaceutical and other animal-related product items by a central product provider, wherein the method allows subsequent recovery of historical pricing information by the central product provider for subsequent sale proceeds sharing with a veterinary hospital. This aspect of the invention comprises the steps of: (a) hosting a website for a veterinary hospital at a central product provider computer; (b) in the central product provider computer, asynchronously creating and storing in a computer readable medium member account details for a veterinary hospital identified by a unique hospital ID; (c) in the central product provider computer, asynchronously creating and storing in a computer readable medium member account details for a veterinary hospital customer identified by a unique customer ID; (d) in the central product provider computer, asynchronously maintaining and storing in a computer-readable medium a plurality of per-item fee records, each fee record comprising at least a unique per-item fee ID, a product item ID, a fee amount, a hospital ID, a pharmacy portion designation and a veterinary hospital portion designation; (e) in a central product provider computer, asynchronously retrieving and storing in a computer readable medium information for a plurality of product item records, each product item record being given at least a unique product item record ID and a current base price, each product item record being received from at least one networked vendor computer; (f) responsive to a request from a hospital customer via the hosted website, in a central product provider computer, creating in computer readable memory a temporary invoice record comprising a unique invoice ID, temporarily storing in the invoice record the veterinary hospital ID of the hospital making the request and providing to the veterinary hospital computer item product information for at least one item for selection; (g) responsive to a selection from the veterinary hospital customer via the hosted website, in the central product provider computer, temporarily storing in the invoice record a snapshot for subsequent optional recall of product item record information comprising at least a unique product item ID, current base price corresponding to the selected product item, at least one per-item fee corresponding to the selected product item, the at least one per-item fee comprising a fee ID and a per-item fee amount, and a selected product item price total comprising the sum of the product item current base price and the at least one per-item fee amount; and (h) making available for display to the veterinary hospital customer via the hosted website the selected item product information and the corresponding total selected product item price.

In accordance with this aspect of the invention, the at least one per-item fee preferably comprises one or more of the following fees: handling fee, pharmacy fee, nutrition fee, item cover fee, wholesale sales tax and distribution fee. Also, preferably in accordance with this aspect of the invention, the steps of the method are repeated for each item product selected for inclusion on an invoice, the method creating an item record temporarily stored in the temporary invoice for each iteration of the steps of the method.

In accordance with another aspect of the invention, the central product provider computer-readable medium further comprises storage for at least one per-invoice fee, each per-invoice fee comprising a per-invoice fee ID and a per-invoice fee amount. In accordance with this aspect of the invention, the following additional steps are preferably provided: (a) in the central product provider computer, responsive to a confirmation by the hospital customer of an intention to purchase the at least one item temporarily stored in the temporary invoice record, retrieving and storing in the invoice record at least one per-invoice fee comprising a fee ID and an associated fee amount; (b) calculating and storing in the invoice record an invoice total comprising each product item price total and the at least one per-invoice fee; and (c) marking the invoice record as open and transferring the invoice record to an invoices database.

In this aspect of the invention, the unique customer ID references a wallet database with at least one set of credit card processing information for the customer, and the method of the invention preferably further comprises the steps of processing payment of the invoice total using the at least one set of credit card processing information, obtaining approval from the credit card financial institution, marking the invoice as paid and releasing the order for fulfillment.

Further, the at least one per-invoice fee in accordance with this aspect of the invention preferably comprises at least one of the following fees: credit card processing fee, shipping fee and applicable federal, state and local taxes. Further, the steps of the method of this aspect of the invention are repeated for each item product selected for inclusion on the invoice, the method creating an item record temporarily stored in the temporary invoice record for each iteration of the steps of the method. Also, it will be appreciated by those of ordinary skill in the art that the central product provider computer, or any other vendor or hospital computer, may preferably comprise a plurality of networked computers.

The steps of the method of these latter aspects of the invention make available to customers of a particular hospital an e-commerce website for enabling hospital pet-owner customers to select and purchase products previously made available by their hospital. This, in turn, enables users to access the hospital's product offering via the hospital's website. In this way, the value added service provided by the hospital to its customers helps solidify the relationship between the hospital and its customer.

Since the system of the invention allows centralized marketing and hospital customization of product selection by hospital staff and animal owner customers associated with a large number of hospitals, enabling custom product offerings of automatically and dynamically priced products for sale, over the Internet, either with an E-commerce application usable by pet owners at their homes, or at a point-of-sale terminal at the animal hospital, the invention effectively accommodates a large number of smaller, in many cases, and disparate veterinary treatment centers—effectively enabling them to participate in the sale of animal-related pharmaceuticals and products directly to their customers. This, in turn, positively impacts compliance with veterinary treatment programs.

As shown in FIG. 1c, the invention places the veterinary hospital 109 in the transaction in a central-product-provider-to-hospital-to-customer relationship and thus enhances the relationship of the hospital 109 and the customer 113, which tends to enhance the care that animals receive. Further, as shown at 123, 124, 125, the hospital avoids the erosion of its profit margin since the invention enables immediate, real-time, pricing increases associated with wholesale and distribution chain price increases as shown in rows A, B and C, at 117, 120, 123; 118, 121, 124; and 119, 122, 125, respectively.

In accordance with yet another aspect of the invention, allocation, crediting and distribution of proceeds of the sale of veterinary products to vendors, taxing authorities, the central product provider and member hospitals is facilitated, whether it be for hospital purchases for their own account, point of sale customer purchases or web-based customer purchase. In accordance with this aspect of the invention, after a sale is facilitated in accordance with a previous aspect of the invention, each at least one fee comprises a fee ID associated with a fee amount, and the product sale proceeds for the hospital are allocated, credited and distributed comprising the steps of: (a) retrieving into a computer-readable medium at least part of an invoice record containing the unique invoice ID, the hospital ID and the at least one fee ID and associated fee amount; (b) for each fee ID from the invoice record accessing an associated fee record in accordance with a match of the hospital ID and fee ID of the invoice record with hospital ID and fee ID fields of the fees database to obtain an associated hospital portion value from the hospital portion field of the fees database; (c) crediting and distributing to the hospital the product of the associated fee amount and the hospital portion value; and (d) marking the invoice as closed.

Alternatively, a computer-enabled method for sale proceeds sharing with a veterinary hospital is provided, comprising the steps of: (a) storing in a computer-readable medium a plurality of fee records, each fee record comprising at least a unique fee ID, a hospital ID and a hospital portion value; (b) retrieving into another computer-readable medium at least part of a marked-paid invoice record containing a unique invoice ID, a hospital ID and at least one fee, the at least one fee comprising a fee ID and associated fee amount; (c) for each fee from the invoice record accessing an associated fee record in the computer-readable medium having a matching hospital ID and a matching fee ID that correspond to the hospital ID of the invoice record and the fee ID of the at least one fee of the invoice record; (d) retrieving the hospital portion value of the associated fee record; (e) crediting and distributing to the hospital the product of the fee amount of the at least one fee and the hospital portion value of the associated fee record; and (f) marking the invoice as closed.

This aspect of the invention provides for allocation and distribution of proceeds based upon updated wholesale pricing and dynamic per-item and per-invoice fee tracking, whether the sale of veterinary products is to the hospital itself for use on its own account, to a hospital customer who purchases at a point of sale hospital computer terminal, or to a hospital, or veterinarian, customer who purchases at an e-commerce website hosted for the hospital by the central product provider.

In accordance with this aspect of the invention, the burden of paying vendors and taxing authorities is effectively removed from the backs of veterinarians and veterinary hospitals.

In this way the large numbers of products commonly available to treat animals are appropriately priced, and historical pricing information is retained to facilitate efficient supply of products to customers, accounting, allocation and distribution of sale proceeds. This avoids the need of the hospital to maintain its own pharmacy, thus saving it the cost and effort associated with having to do so, while at the same time giving the hospital access to participate in the product sales chain. This, in turn, yields better care for the animals, since involving a veterinarian in the treatment of the animal is encouraged and further veterinarian treatment plans are more likely to be complied with, because participation of the veterinarian throughout the process is incentivized.

Since the system of the invention allows appropriately priced products to be sold over the Internet, either with an E-commerce application usable by the pet owner at his or her home, or at a point-of-sale terminal at the animal hospital, with convenient delivery of the ordered product to the customer's doorstep, the invention effectively accommodates a large number of smaller, in some cases, and disparate veterinary treatment centers—effectively enabling them to participate in the sale of animal-related products directly to their customers—thus positively impacting compliance with veterinary treatment programs.

This aspect of the invention is primarily intended for products not requiring a prescription authorization from the veterinarian hospital, such as supplements, feeds, over-the-counter treatment regimens and the like. However, this aspect of the invention may enable a user to purchase re-fills of already authorized pharmaceuticals as well. For example, a veterinarian may authorize a heartworm medication for an animal that may be renewable for six months. If the customer didn't want to purchase all six months in advance, he or she could access the hospital's website through a secure account to purchase pre-authorized refill medications for which the animal has already been seen by the veterinarian.

Since in accordance with the present invention the veterinarian is conveniently placed at the center of the supply of pharmaceuticals and other products in the processes of the invention, the veterinarian is supported in providing better care to the animal and in enabling better compliance by the animal owner with treatment plans. This coherent, comprehensive, veterinarian-centric method and system of supplying animal-related products to animal owners for administering treatments to their animals fosters appropriate and best practices for practicing veterinarian medicine.

The subject matter of the present invention is particularly pointed out and distinctly claimed in the concluding portion of this specification. However, both the organization and method of operation, together with further advantages and objects thereof, may best be understood by reference to the following descriptions taken in connection with accompanying drawings wherein like reference characters refer to like elements.

### BRIEF DESCRIPTION OF THE DRAWINGS

FIG. 1a is a schematic representation demonstrating prior art static pricing in a veterinary-hospital-pharmacy-type channel for veterinary pharmaceuticals and other animal products;

FIG. 1b is a schematic representation demonstrating prior art static pricing in a central-product-provider-pharmacy-type channel for veterinary pharmaceuticals and other animal products;

FIG. 1c is a schematic representation demonstrating the benefit of the invention to pricing in a central-product-provider-to-hospital-to-customer-type channel for veterinary pharmaceuticals and other animal products;

FIG. 2 is a schematic representation illustrating an overall system comprising client computers, servers and databases for pricing and product sale proceeds allocation and distribution for animal-related product sale orders;

FIG. 3a is a schematic diagram of part of a system in accordance with the present invention for asynchronously updating in a computer readable medium at a central product provider computer details, including hospital, customer and wallet information, for a veterinary hospital member of the central product provider system;

FIG. 3b is a schematic diagram of part of a system in accordance with the present invention for asynchronously updating in a computer readable medium at a central product provider a plurality of per-product-item fee records and per-invoice fee records;

FIG. 3c is a schematic flow diagram of part of a system in accordance with the present invention for asynchronously updating in a computer readable medium at a central product provider computer veterinary product record details;

FIG. 4 is a schematic process flow diagram illustrating the aggregation of per item fees associated with each animal product item of an invoice in accordance with part of the present invention;

FIG. 5 is a schematic process flow diagram illustrating the aggregation of per invoice fees associated with each invoice in accordance with part of the present invention;

FIG. 6 is a schematic process flow diagram illustrating the processing of payment for purchase of animal products in accordance with a part of the present invention;

FIG. 7 is a schematic process flow diagram illustrating the allocation and distribution of product sale proceeds to vendors, regulatory agencies, veterinary hospitals and a centralized pharmacy in accordance with a part of the present invention;

FIG. 8 is an entity relationship diagram illustrating preferred organization of data structures of computer readable medium of a central product provider computer for a master products database, fee tables, hospital membership profiles, customer membership profiles and credit card wallets in accordance with a part of the present invention;

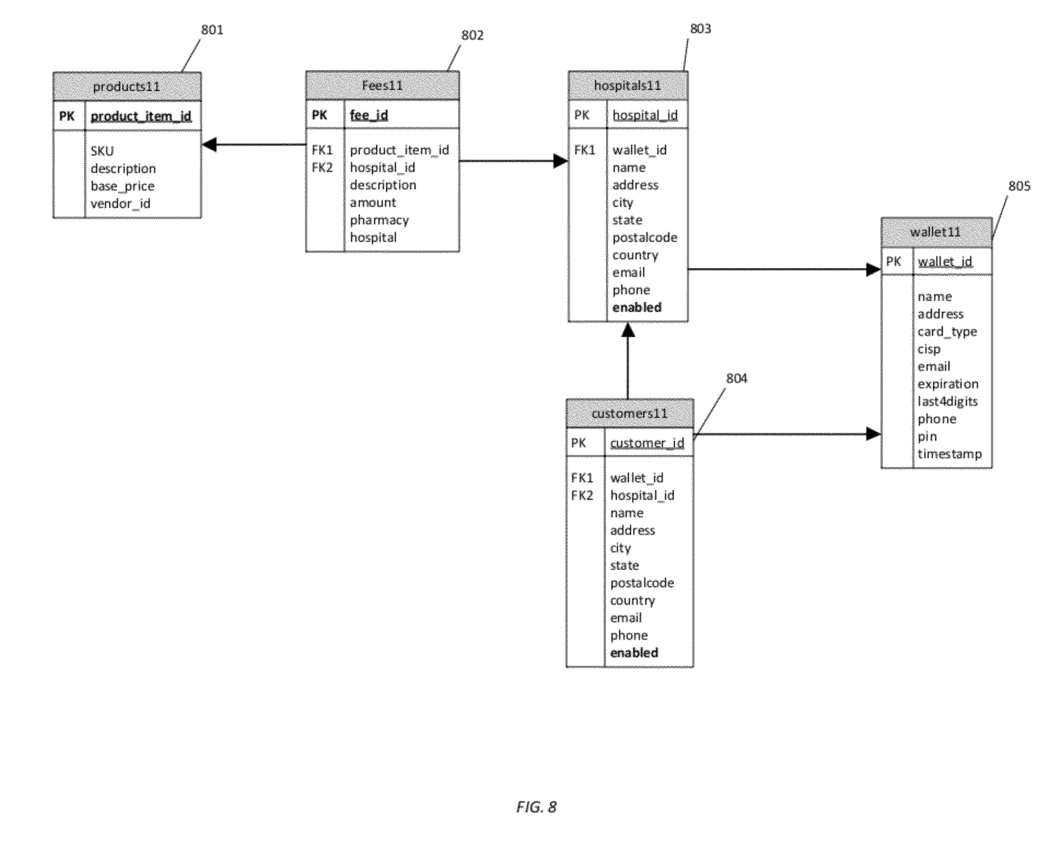

FIG. 9 is an entity relationship diagram illustrating preferred organization of data structures of computer readable medium for invoices introduced into the central product provider, each invoice having one or more items and any associated per-item and per-invoice fees in accordance with part of the present invention;

FIG. 10 is a table showing invoice status and the meaning of each status option;

FIG. 11 is a schematic diagram illustrating preferred organization of a data structure of computer readable medium for an invoice record in accordance with part of the present invention;

FIG. 12 is a schematic diagram illustrating preferred organization of a data structure of computer readable medium for a per-item fee record in accordance with part of the present invention; and

FIG. 13 is a schematic diagram illustrating preferred organization of a data structure of computer readable medium for a per-invoice fee record in accordance with part of the present invention.

### DETAILED DESCRIPTION

### System Overview

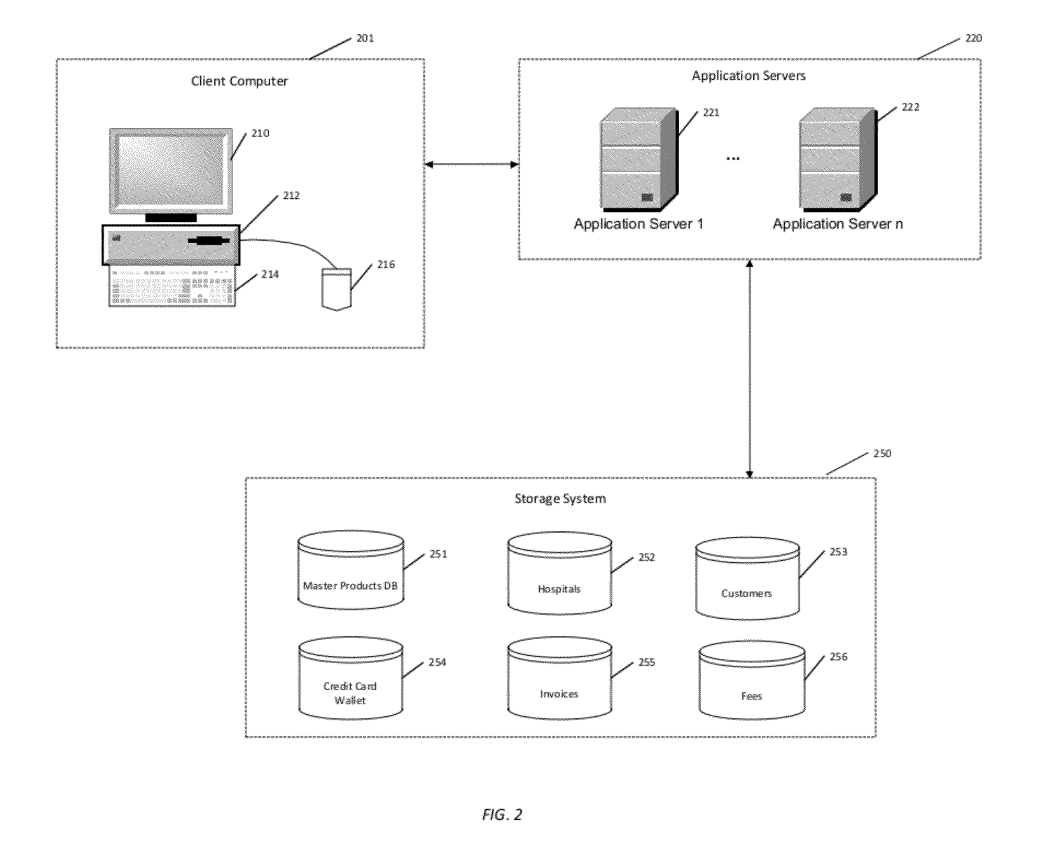

Referring to FIG. 2, client computer system 201 is one of a plurality of such client computer systems being located at a veterinarian hospital, including any animal treatment facility or location where a licensed veterinarian is authorized to do business, and the application server systems 220 with supporting data storage system 250 may support many such hospitals having such plurality of client computer systems 201. As is important to an alternative embodiment of the invention, client computer system 201 may be, alternatively, a client computer system in an animal hospital's customer's home.

While each client computer system 201 preferably comprises a traditional monitor 210, processing hardware 212, keyboard 214, mouse 216, application software, Internet software and hardware components (not shown), it will be appreciated by those of ordinary skill in the art that any computer system, such as a smart phone, hand-held device, laptop, or other equivalent computing device with adequate memory and processing capability will satisfy the client computer system for purposes of the present invention. Further, multiple client computer systems 201 may be networked, for example on an Ethernet-type network within a hospital complex, the networked systems being represented in whole by client computer system 201 as is well understood by those of ordinary skill in the art. Further, it will be appreciated by those of ordinary skill in the art that, since many veterinarians work independently, the invention may be used by individual veterinarians by considering the veterinarian and the hospital to be one and the same in the database.

Client computer systems 201 may run any type of client computing operating system and software, such as Windows®, Mac OS®, Linux®, Android® or others, that enables access by the user of the client computer system to the Internet and the ability to process application data within the client portion of the application software of the invention on the client computer system.

One or more application servers 220, comprising parallel processing, mirrored, or RAID configured servers 221, 222, etc., run the server side portion of the application software of the invention and provide secure access to data in the storage system 250. Servers 220 may comprise a plurality of servers that are housed in a single location where the size of the system permits and there exists sufficient power and security to meet reliability and availability needs. The servers 220 are preferably interconnected to each other and to data storage system 250 by a high-speed local networking system. Servers 220 are also connected to the plurality of client computers 201 via the Internet or other network system.

Storage system 250 preferably comprises a redundant array of magnetic storage media disk drives, optical storage system, or the like, capable of the fast access and retrieval times necessary to accommodate many requests in rapid succession from the multiple client computer systems 201 and application servers 220.

Storage system 250 houses a plurality of databases corresponding with key elements of data preferable for a central product provider and veterinarians at their respective hospitals to generate product sales information from product item records selected from the master products database 251 for fulfillment to the hospital, or customer of the hospital, by the central product provider or pharmacy.

In accordance with the present invention, there is stored at the central product provider computer, otherwise known as the application server or servers 220, a master product database 251, a hospitals database 252, a customers database 253, a credit card wallet 254, an invoices database 255 and a fees database. The master product database 251 comprises computer readable medium in which is stored a complete list of all products that individual hospitals may, or may not, choose to buy for their own account or offer for sale to customers. Each product item record in the master products database 251 is identified at least by a unique item ID and a wholesale price, but other information, such as SKU, description and other product related information may also be included.

### Databases and Data Structures

The hospitals database 252 comprises a list of all member hospitals authorized to do business with the central pharmacy. In the hospitals database 252, each hospital's data preferably comprises hospital's unique ID, contact information, and other relevant, hospital-specific information.

The customers database 253 comprises a computer-readable medium in which is stored a list of all member hospitals' customers authorized to do business with the central pharmacy. In the customers database 253, each customer's data preferably comprises the customer's unique ID, an associated hospital ID, customer contact information, and other relevant, customer-specific information.

The credit card wallet database 254 comprises a computer-readable medium in which is stored credit card information, for both hospitals and hospitals' customers, necessary for processing of payment for products with a credit or debit card. For each entry in the wallet there are listed a unique wallet ID, a hospital ID and a customer ID when necessary to process a payment from a customer. Further, it will be appreciated that it is advantageous to have backup credit card information for each hospital and customer in the database in the event that primary credit card information is outdated or otherwise ineffectual.

Invoice Record Detail

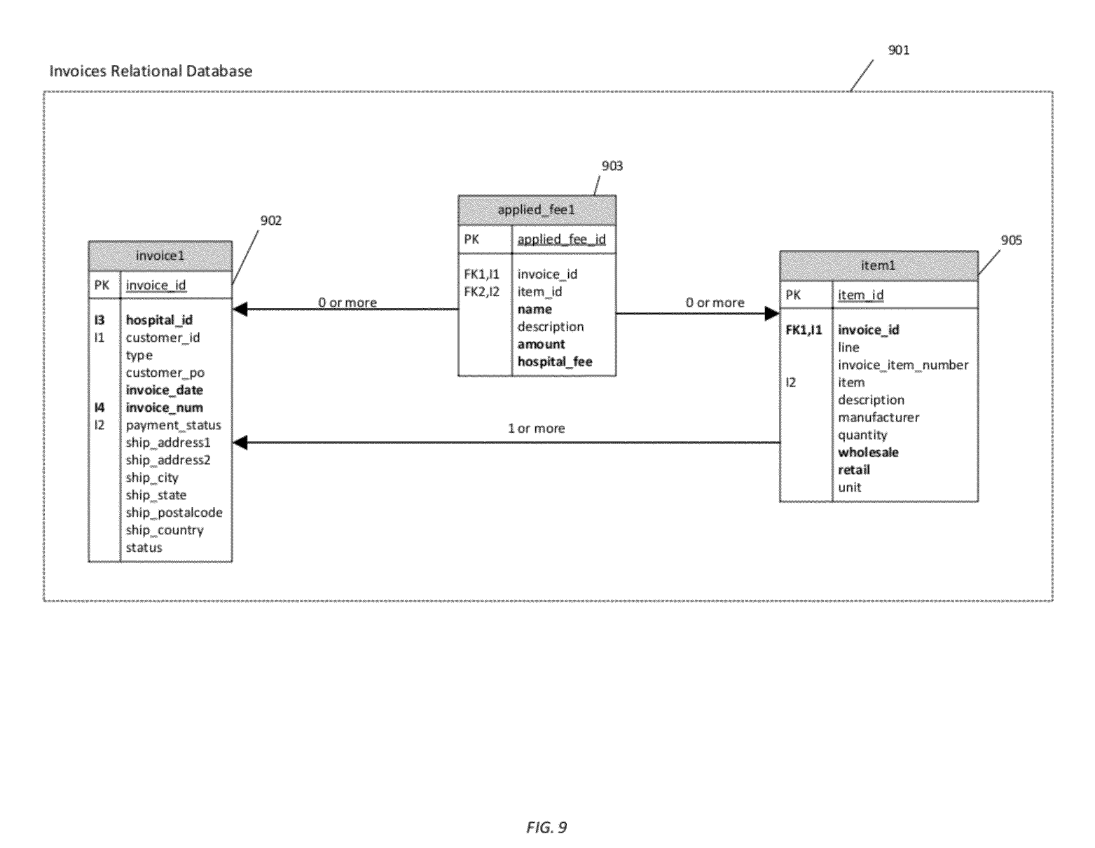

The invoices database 255 (FIG. 2) comprises a computer-readable storage medium for recording invoice records based upon product sale transactions between the central product provider and the veterinary hospital or its customers. As shown at FIG. 9, the database is a relational database comprised of the following three tables: invoice table 902, line item 905 and applied fee 903. Each invoice in the invoice table is identified by a unique invoice ID, each line item in the line item table 905 is identified by a unique line item ID and each applied fee in the applied fee table 903 is identified by a unique applied fee ID. The relationship between the tables is such that each entry in the invoice table, identified by its unique invoice ID, is related to one or more line items for that invoice, by the fact that the unique invoice ID occurs in invoice ID field of the line item table of one or more line item records corresponding to those line items to be included on that invoice. Similarly, there are associated per-item and per-invoice fees with each invoice as shown. This relationship is defined for per-item fees by the instance of zero or more per-item fees in the applied fee table 903 having a line item ID for the associated line item record on the invoice, signifying that there may be zero or more fees associated with a particular line item record. Further, this relationship is defined for per-invoice fees by the instance of zero or more per-invoice fees in the applied fee table 903 having an invoice ID for the associated invoice record, signifying that there may be zero or more fees associated with a particular invoice.

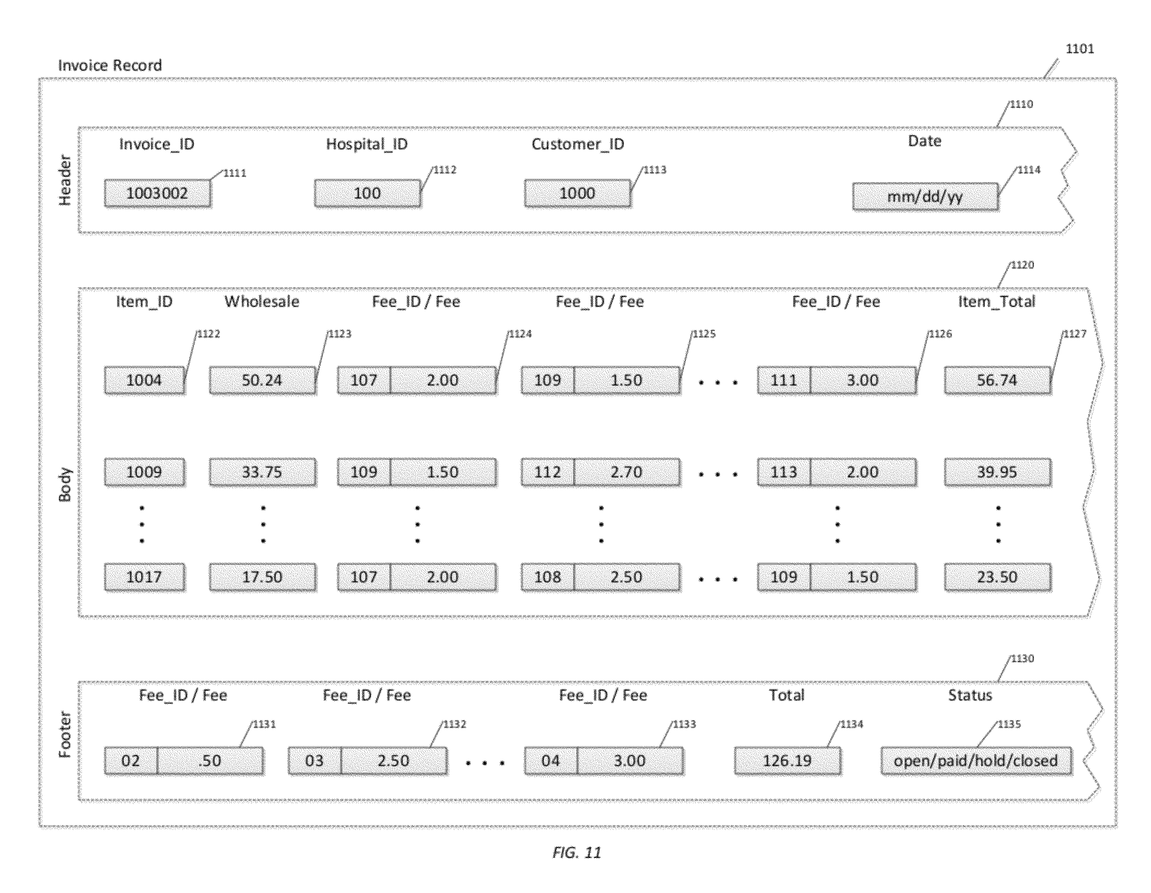

Referring specifically to FIG. 11, there is shown the memory data structure for an entire invoice record 1101. In the header portion 1110 of the record there is a unique invoice ID 1111, a hospital ID 1112, and a date 1114 and depending on whether a transaction is initiated by a hospital for its own account, or by a customer for retail purchase, optionally, a customer ID 1113.

In a body portion 1120 of the invoice record 1101, there are one or more line item records, one line item record for each product to be purchased. Each line item record comprises a product item ID 1112, wholesale price 1113, one or more per-item applied fee IDs and associated amounts 1114-1116 and a product item total 1117.

In a footer portion 1130 of the invoice record 1101, there are one or more per-invoice applied fee IDs and associated amounts 1131-1333, an invoice total 1134 and an invoice status field 1135.

Per-Item and Per-Invoice Fee Database and Detail

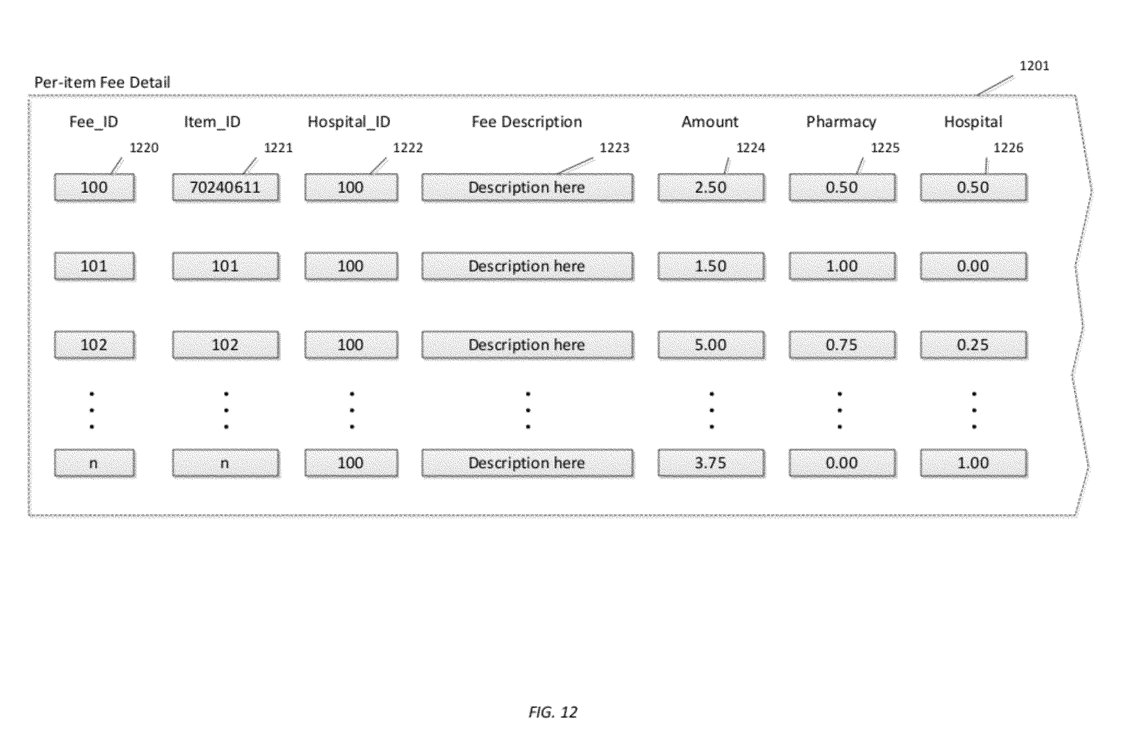

The fees database 256 comprises a computer-readable storage medium for storing per-item fees and descriptions, as shown in FIG. 12, associated with each particular item in the master products database 251 (See FIG. 2) for the purpose of establishing the fee amount 1224 and the percentage fee splits 1225, 1226 for later allocation and distribution of sale proceeds to the hospital. Each per-item fee record also has associated with it a unique fee ID 1220, product item ID 1221, hospital ID 1222 and fee description 1223.

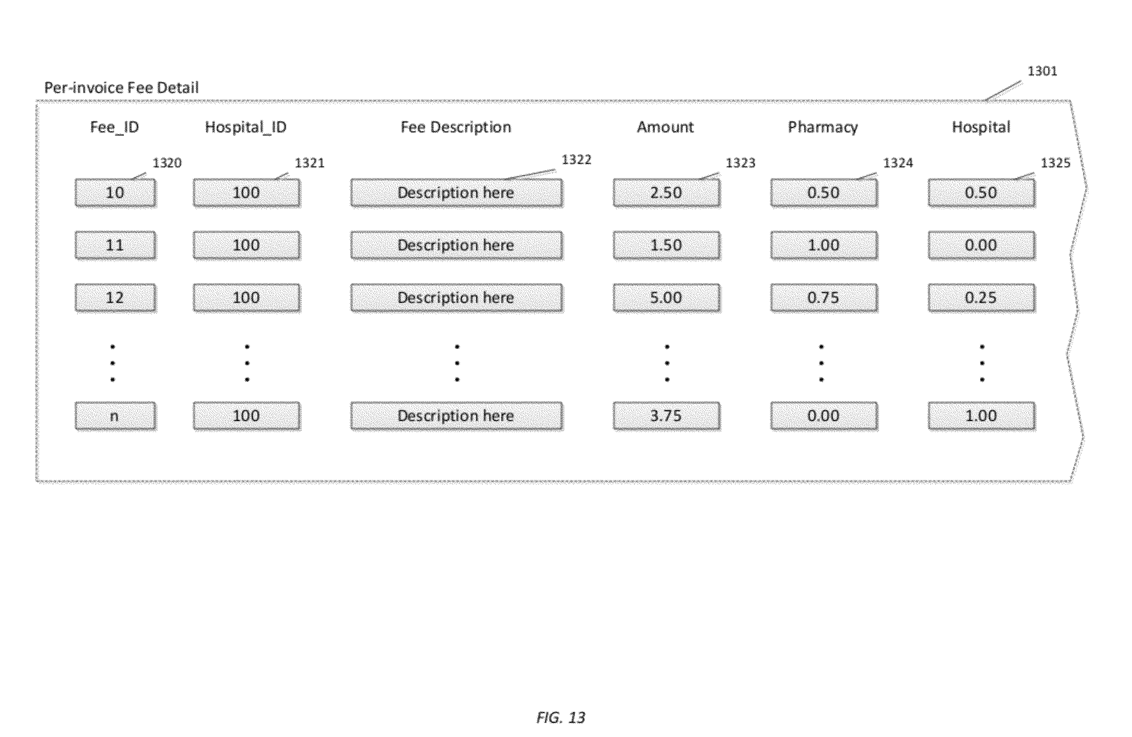

Further, the fees database 256 comprises a computer-readable storage medium for storing per-invoice fees and descriptions, as shown in FIG. 13, for the purpose of establishing a per-invoice applied fee amount in accordance with per-invoice fee amount 1323. Each per-invoice fee record comprises a unique fee ID 1320, hospital ID 1321, fee description 1322, per-invoice fee amount 1323 and the percentage fee splits 1324, 1325 for later determination and credit of sale proceeds to the veterinary hospital.

It will be appreciated by those of ordinary skill in the art that the percentage fee splits associated with both the per-item fees shown in FIG. 12 and the per-invoice fees shown in FIG. 13 may also be used for the purpose of later determination and credit of sale proceeds to the central product provider, its vendors, and any other parties participating in transactions. Thus, it will also be appreciated from the forgoing that the difference between a per-item fee and a per-invoice fee is the presence of a product item ID in the case of a per-item fee and the absence (null value) of a product item ID in the case of a per-invoice fee in the database 256. Further, will be appreciated by those of ordinary skill in the art that there are other ways to differentiate between these fee items in the same database, they may be separated into separate databases or other means of designating the difference may be employed without departing from the spirit of the invention as claimed.

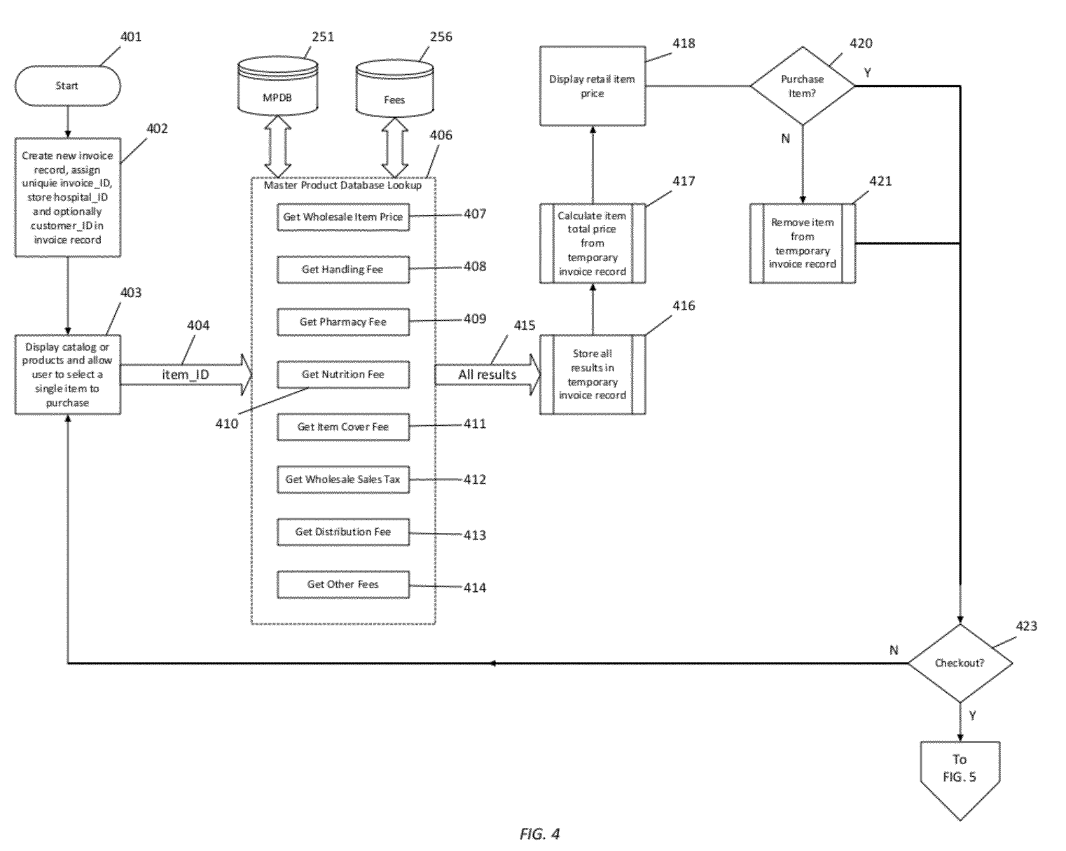

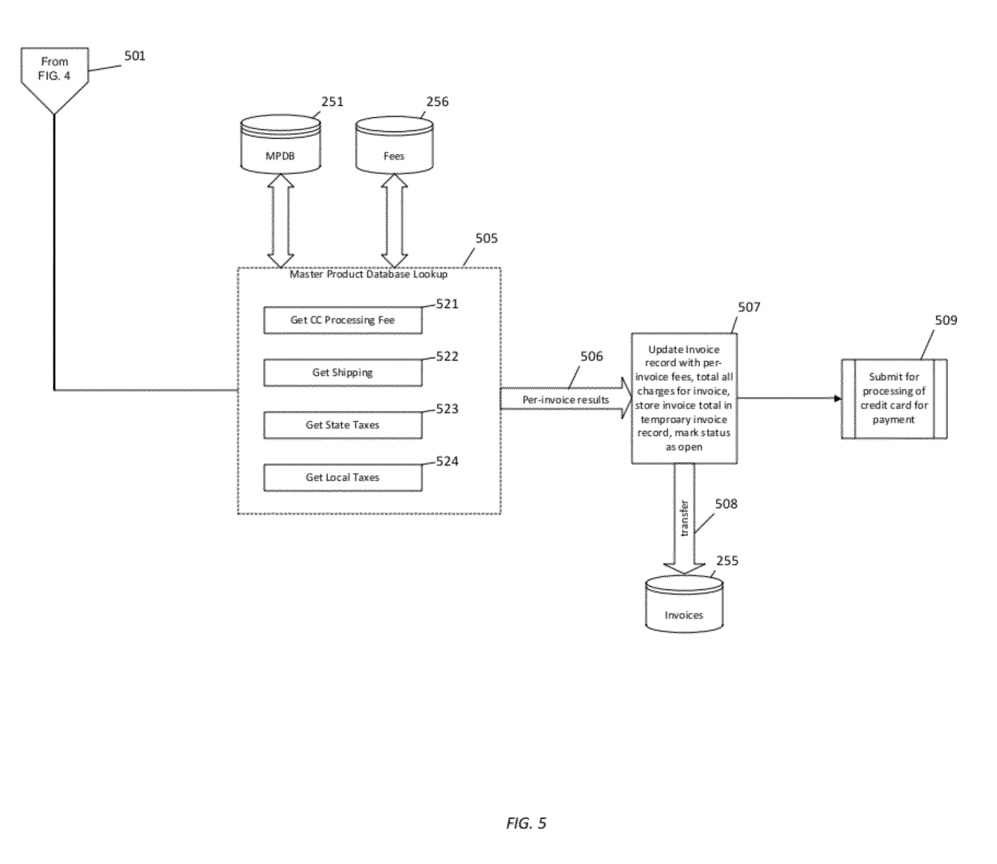

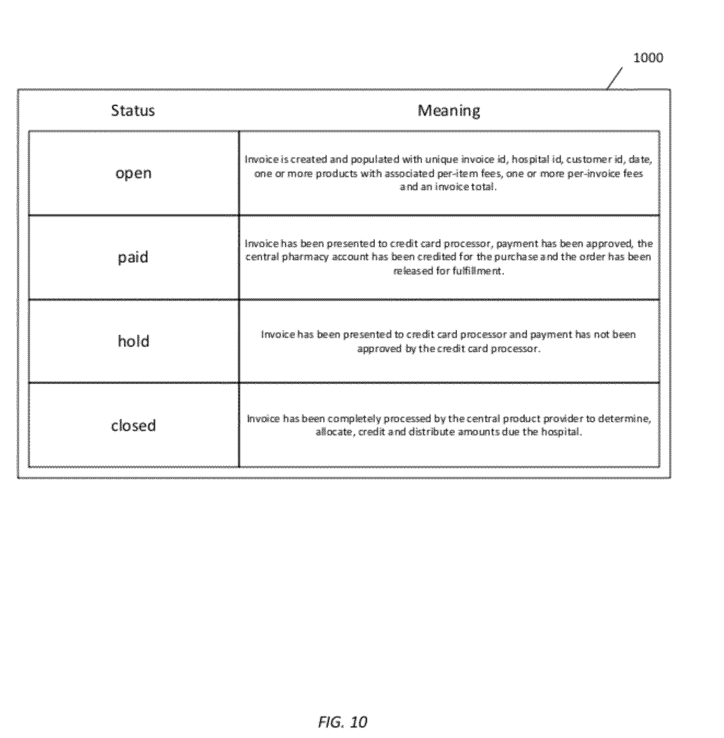

Referring to FIGS. 10 and 11, there is shown a table 1000 describing the various status options for the status field 1135 of an invoice record 1101. The status field 1135 is set to open when the invoice is first created and populated with a unique invoice ID, hospital ID, customer ID, date, one or more product items with any associated per-item fees are added to the invoice, any per-invoice fees are added to the invoice and the invoice is totaled all as accomplished as shown on FIGS. 4 and 5.

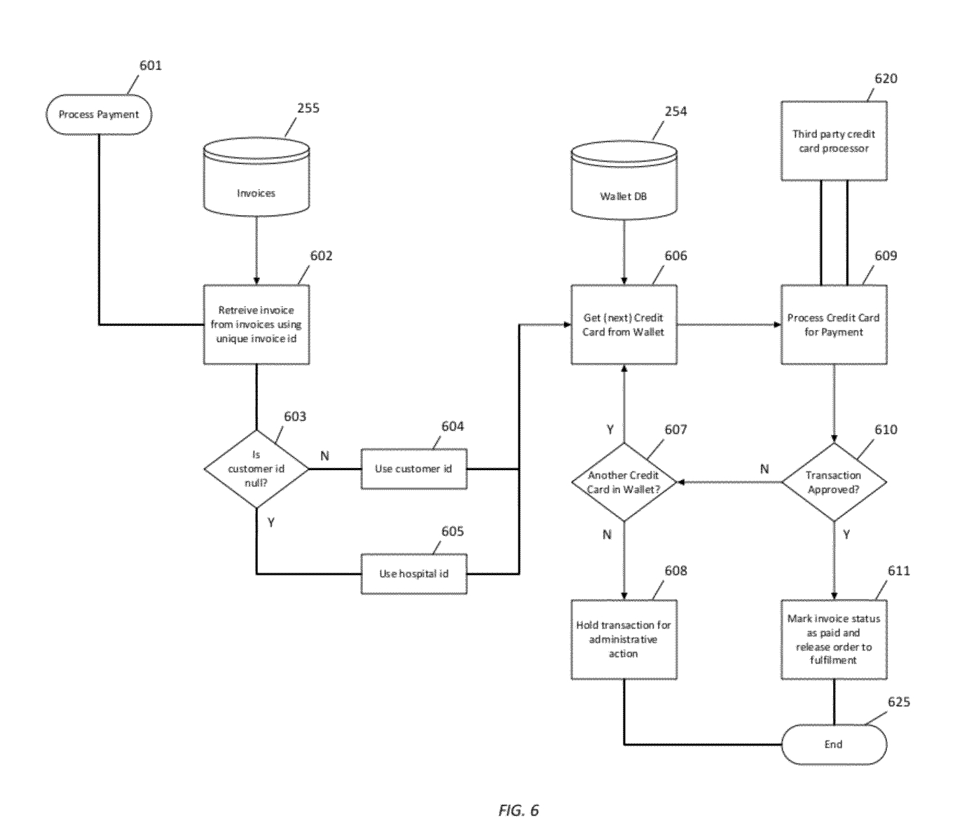

The status field 1135 is set to paid when the invoice has been presented to a credit card processor, payment has been approved by the credit card processor, the central pharmacy account has been credited for the purchase and the order has been released for fulfillment all as accomplished at 611 on FIG. 6.

The status field 1135 is set to hold when the invoice has been presented to a credit card processor and payment has not been approved by the credit card processor as shown at 608 on FIG. 6.

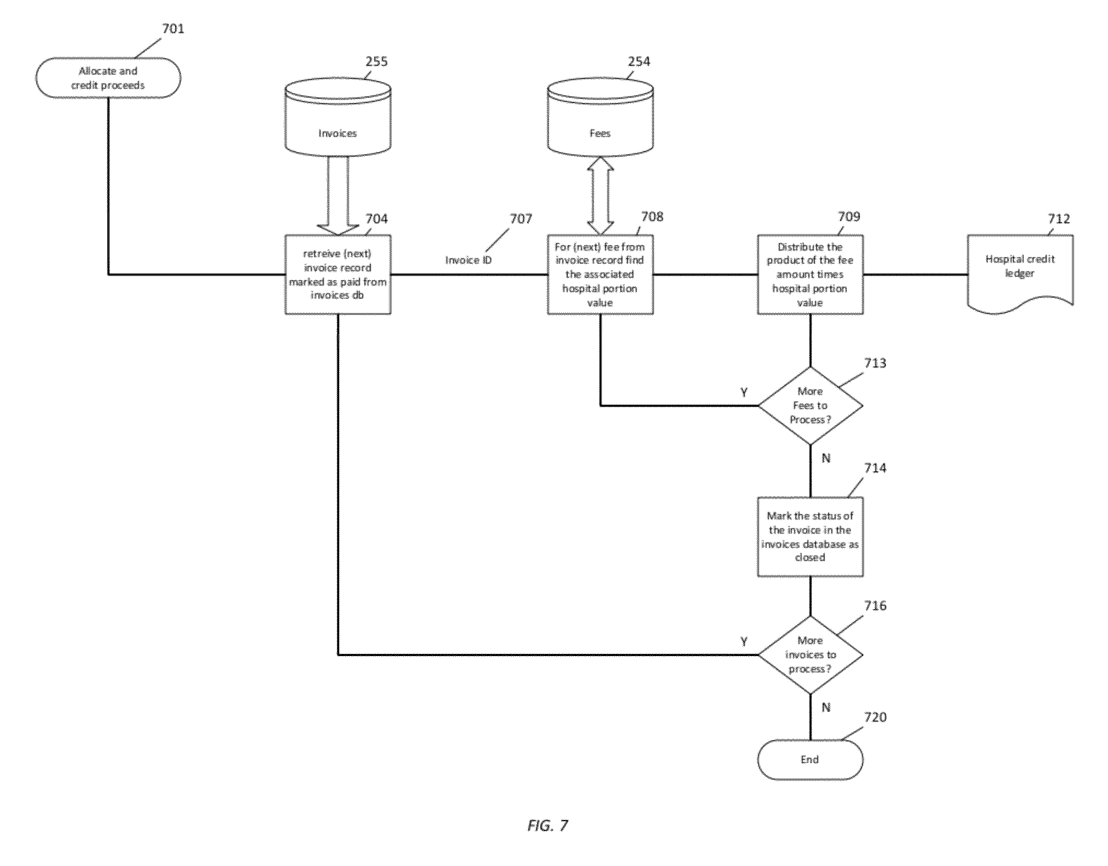

The status field 1135 is set to closed when the invoice has been completely processed by the central product provider to determine, allocate, credit and distribute amounts due to the hospital account as a result of the sale transaction as shown at 709 on FIG. 7.

### Product Sale and Proceeds Distribution Processes

Member Profile Creation and Maintenance

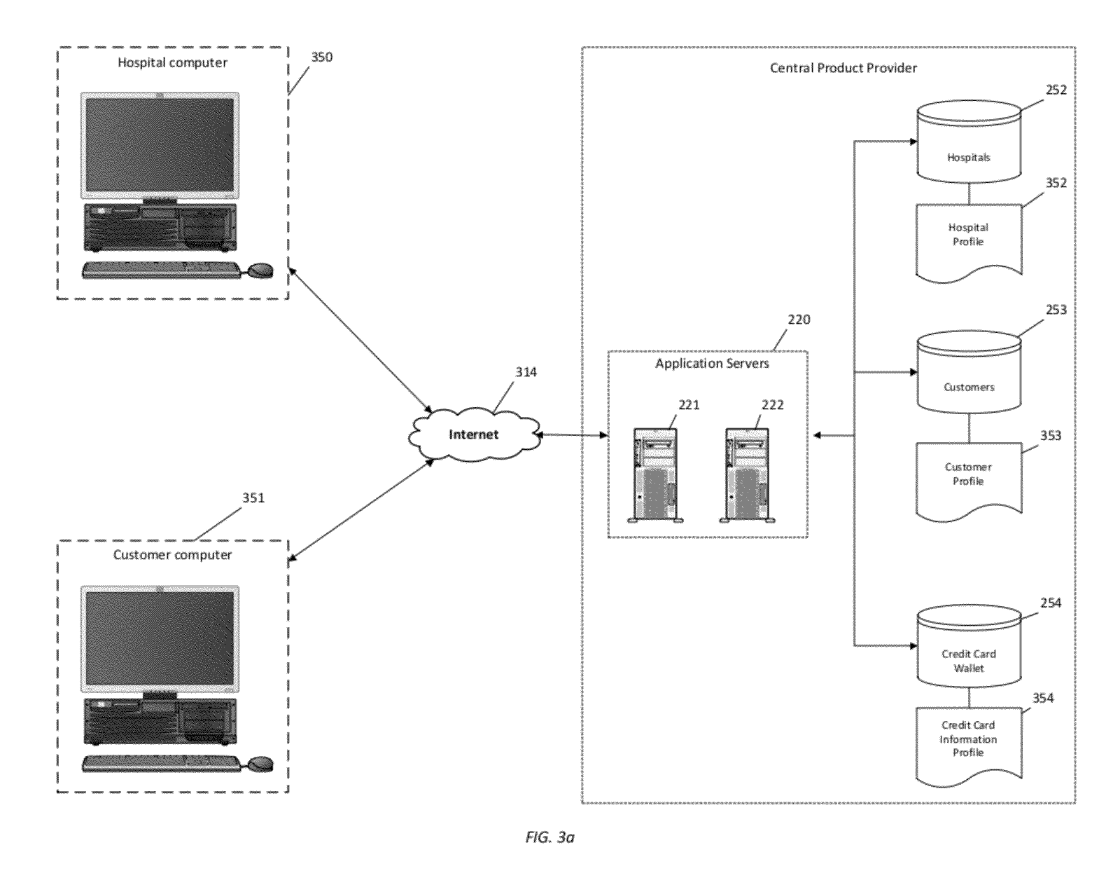

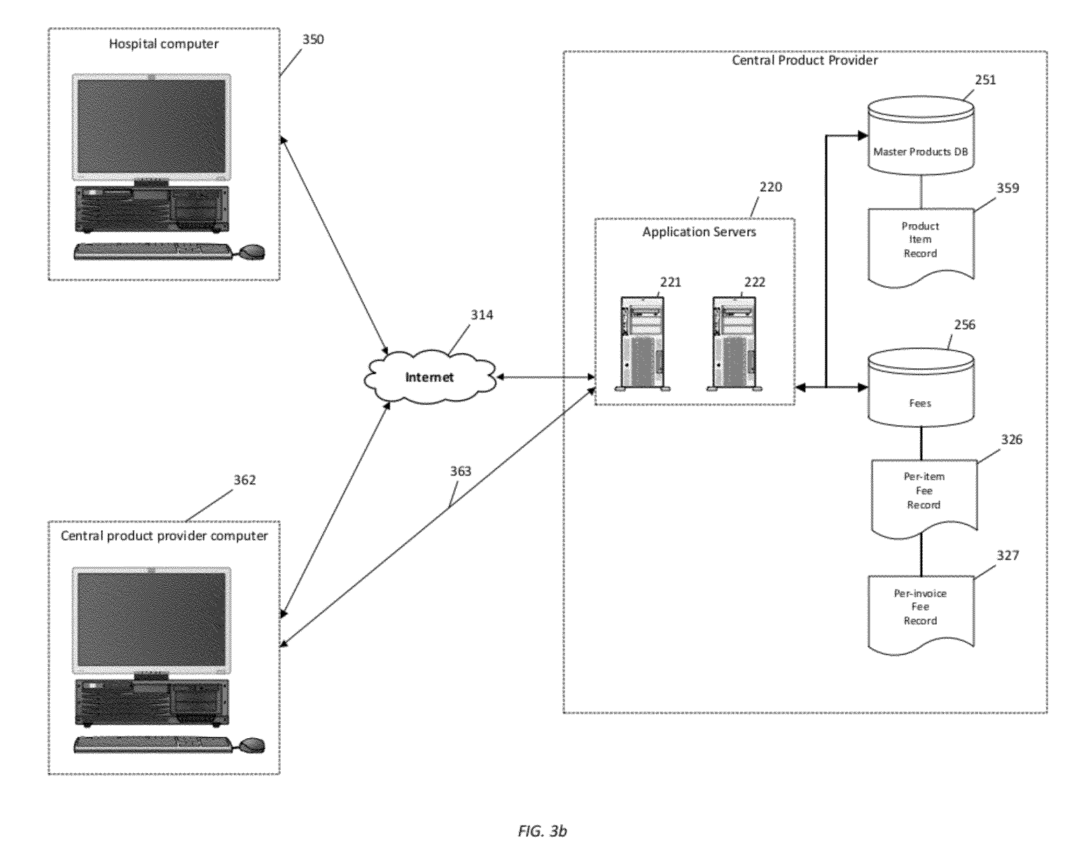

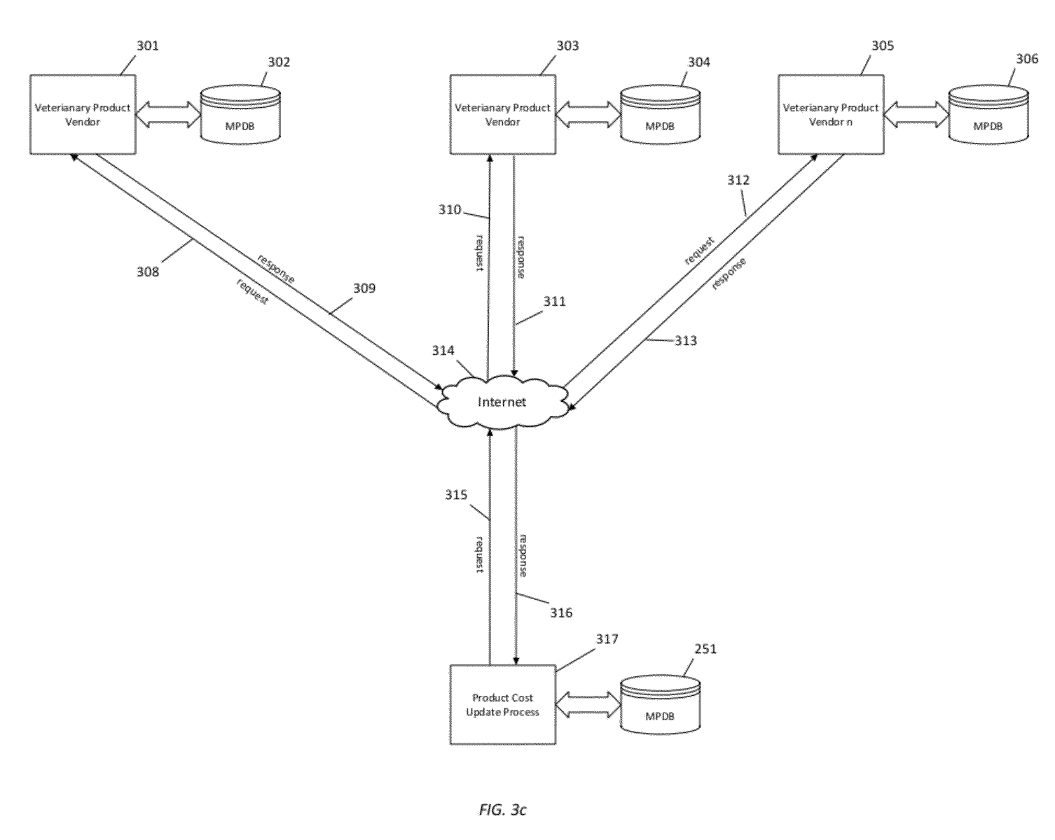

Referring now to FIGS. 3a, 3b, 3c, 4 and 5 a computer-enabled method for dynamic, automated pricing of veterinary pharmaceutical and other animal-related product items by a central product provider is disclosed, wherein the method allows subsequent recovery of historical pricing information by the central product provider for subsequent sale proceeds sharing with a veterinary hospital.

Referring now to FIG. 3a, there is shown a hospital computer 350 for communicating over the Internet 314 with application servers 220 which in turn comprise or communicate with databases 252, 253, 254 for a central product provider, such as a central veterinary pharmacy. Veterinary hospital member account details, such as veterinary hospital membership profiles 352, are created, stored and maintained in the computer readable medium of the hospital's database 252 and are identified by a unique hospital ID. Customer account details, such as customers' membership profiles 353, are created, stored and maintained in the customers database 253 computer readable medium and are identified by a unique customer ID. Credit card information profiles 354 for both hospitals and customers are created, stored and maintained in the credit card wallet database 254 computer readable medium and are identified by a unique credit card wallet ID. As is customary in the art, it is contemplated that each hospital and customer may preferably have more than one credit card information profile 354 in the credit card wallet database 254 associated with their hospital profile 352 or customer profile 353 respectively. Each hospital account credit card profile 354 in the credit card wallet database 254 is related to a hospital profile 352 by the presence of a hospital ID in the credit card profile. Similarly, each customer account credit card profile 354 in the credit card wallet database 254 is related to a customer profile 353 by the presence of a customer ID in the credit card profile.

Similarly, FIG. 3a shows a customer computer 351 for communicating over the Internet 314 with the central product provider application servers 220 during those transactions where a customer purchases product directly over the Internet from a home computer via a website hosted for the customer's hospital by the central product provider servers 220.

The creation, storage and maintenance of the profiles described in connection with FIG. 3a are further described in the DATABASE AND DATA STRUCTURES Section of the Detailed Description and comprise ongoing operations able to be performed asynchronously. However, it is necessary for a hospital profile 352 to exist before a hospital can purchase products from the central product provider for its own account. Also, if a hospital attempts a products purchase transaction for its own account without at least one valid credit card information profile, the transaction would be denied. Further, it is necessary for both a hospital profile 352 and a customer profile 353 to exist before a customer can purchase at a point of sale transaction in the hospital or over the Internet from a customer's own computer. Also, if a customer attempts a products purchase transaction without at least one valid credit card information profile, the transaction would be denied.

Fee Records Creation and Maintenance

Referring to FIG. 3b, there is shown the hospital computer 350 for communicating over the Internet 314 with computer application servers 220 for the central product provider, having asynchronously created, stored and maintained thereon in a computer readable medium a fees database 226 containing a plurality of per-item fee records and per-invoice fee records comprising individual per-item fee records 326 and individual per-invoice fee records 327. As shown in FIG. 3b, the application servers 220 also communicate with the master products database 251 having stored thereon a plurality of product item records 359, each item record being identified by a unique product item ID. Each fee record 326, 327 is associated with a hospital profile 352 by the presence of a matching hospital ID in the hospital field of each fee record. Additionally, each per-item fee record 326 is associated with a product item record 359 in the master products database 251 by the presence of a product item ID in the per-item fee record 326. As shown in FIG. 12, each per-item fee record comprises at least a unique fee ID, a product item ID, a fee amount, a hospital ID, a pharmacy portion designation and a veterinary hospital portion designation. Preferably, each per-item fee record also contains a fee description field.

Further, FIG. 3b shows a central product provider computer 362 for communicating over the Internet 314, or over a direct internal network connection 363, with the central product provider application servers 220 for the purpose of creating and maintaining the fees database 226 and the master products database 251 as well. A hospital administrator uses hospital computer 362 to establish and maintain hospital originated fees in the fees database 226 for product items to be sold on behalf of that particular hospital. The hospital administrator is only permitted to access fees that they have created or have been given access to by the central product provider.

The creation, storage and maintenance of fee records 326, 327 in connection with FIG. 3b are further described in the DATABASE AND DATA STRUCTURES Section of the Detailed Description and comprise ongoing operations able to be performed asynchronously. However, if there is no fee record for a particular product or hospital in the fee database, the process of invoicing for that hospital will proceed with no fees being applied to the invoice. The presence of fees in the fee database determines whether a fee is applied to a product or invoice or not. This fact accommodates a simplified system for dynamically updating fees, whether they be per-item fees or per-invoice fees, at any time, for future application to sold products and invoices. Upon adding a new fee to the fees database, it is then available for the system to automatically apply the new fee during the very next product sale transaction accomplished in accordance with the method of the invention. Likewise, modification or removal of fees in the fees database have a similar dynamic and automatic effect on product sales and subsequent proceeds allocation and distribution.

Product Pricing Update

Referring to FIG. 3c, a product information cost update process 317 in the central product provider computer 220 (see FIG. 3b) interacts with the computer readable medium of the master products database 251 that contains a plurality of product item records 320, an item record for every product the central product provider sells. Each item record contains at least a unique product item record ID, a current base price, a vendor ID, and preferably, a SKU number and a product description. The computer readable medium of the master products database 251 may be asynchronously and continuously updated by retrieving and storing product item data to reflect changing costs of products at the central product provider. These updates are accomplished when the process 317 selects a product, according to its product ID or SKU number, for update, determines the vendor via the vendor ID from that product record, and directs a request 315, 308 via the Internet 314, to the vendor (in this case vendor 301). Responsive to the request, the vendor 301 determines the current pricing for the product item in the vendor computer's product database 302 and returns current pricing in response 309, 316 via the Internet 314. Using this response, the product information cost update process 317 updates the master product database 251 with the current established price from the vendor. This product pricing is stored in the product item record 320, and this new pricing will take effect on the next invoice for sale of that product to a hospital or customer of the hospital.

As shown, the products in the master products database 251 are sourced from a plurality of vendors 301, 303, 305, there being little, if any, practical limit to the number of vendors that may provide products to the central product provider. The process cycles through the entire master products database 251, continuously or at predetermined times depending upon administrator choice, so that all prices associated with every product in the master products database are dynamically refreshed and current and immediately available for automated application for generated invoices.

Per-Item Fee Aggregation Phase

Referring now to FIG. 4, a per-item fee aggregation phase is shown wherein a hospital or customer requests product information for selection and purchase from the central product provider via a hospital computer, or in the case of a web-based purchase via a customer home computer (hereafter referred to as the “client computer”), thus initiating the product selection, pricing, invoicing and sale process at 401. In response to the information request from the client computer, at 402 a new invoice record comprising a unique invoice ID, an associated hospital ID, and an associated customer ID is created in an invoice record in temporary computer readable medium or memory. Also, responsive to the information request, a catalog display of at least one product item, but preferably a plurality of product items, is provided by the central product provider computer to the client computer to allow a user at the client computer to select a single product item for review and possible purchase as shown at 403.

Responsive to the selection of an item from the catalog, the item's item ID is transferred to the central product provider's computer system as shown at 404, at which time the central product provider determines the retail sale price for the item selected by looking up the requested item in the master product database 251, retrieving the associated current base price 407 and using the hospital ID and the product item ID to retrieve applicable associated per-item fees 408-418 from the fees database 256. Responsive to the selection, or choice to shop, from the client computer, the results of this retrieval—otherwise known as a snapshot of current price information at the time of the initial selection of a product and amounting to a quote to deliver the product to a customer for the stated price—are stored in the invoice in temporary computer readable medium memory as shown at 416 for subsequent optional recall of product item record information. As implied above, the item total price is calculated at 417 from the current item base price and all associated per-item fees. The per-item fees 408-414 comprise such fees as a handling fee 408, pharmacy fee 409, nutrition fee 410, item cover fee 411, wholesale sales tax 412, distribution fee 413 and other fees 414. Zero or more of the per-item fees 408-414 may be included in the snapshot, however at a minimum the snapshot must include a product item ID, a current base price corresponding to the selected product item and the item price total comprising the sum of the product item current base price and any applicable per-item fee amounts. Further, preferably at a minimum, the snapshot comprises at least one per-item fee amount. The calculated total and related product item information are displayed on the client computer along with a button programmed to allow addition of the product item to a shopping cart, which in turn adds a line item to the invoice record as shown at 418.

At this point, at 420 the user at the client computer can choose to add the product item to the shopping cart, and thus to the invoice. If so, the temporarily stored results are moved to a line item on the invoice record in temporary memory according to the data structure shown in FIG. 11. If not, the temporarily stored results are ignored or discarded. In either case, the user at the client computer is given the opportunity to check his or her product items out or to continue shopping. If the user does not wish to check out, for example if there are additional items that the user would like to add, and the steps at 403-420 are repeated for a next product selected by the user. If the user does want to check out, for example if the user at the client computer is done shopping and would like to purchase the product item or items currently in the shopping cart, the item addition phase of the method is complete and control is transferred to a per-invoice fee aggregation phase of the method beginning at 501 of FIG. 5.

Per-Invoice Fee Aggregation Phase

Referring specifically now to FIGS. 5 and 3b, there is disclosed a per-invoice fee aggregation phase of the method of the invention wherein the computer readable medium of the central product provider computer 220 further comprises storage for at least one per-invoice fee, each per-invoice fee comprising a per-invoice fee ID and a per-invoice fee amount in a fees database 256. In the central product provider computer, responsive to a confirmation of an intention by the user to check out and purchase the at least one item temporarily stored in the temporary invoice record as shown at 423 of FIG. 4, the per-invoice fee aggregation phase of the method comprises the step of using the hospital ID to retrieve as shown at 505 at least one per-invoice fee 521-524 from the fees database 256. As shown at 506, 507 the retrieved per-invoice fees 521-524 are temporarily stored in the temporary invoice record for subsequent optional recall of invoice record information. The results of this retrieval and storage shown at 505, 506, 507 are otherwise known as a snapshot of current per-invoice fees as of the time of checkout at 423 on FIG. 4. The per-invoice fees 521-524 comprise such fees as credit card processing fee 521, shipping fee 522, state taxes 523 and local taxes 524. Preferably, each per-invoice fee comprises at least a fee ID, a hospital ID and an associated fee amount as suggested in FIG. 13. Zero or more of per-invoice fees 521-524 may be retrieved and included in the snapshot. Continuing at 507, all charges for the invoice, including each product item price total and any per-invoice fees, are stored in the temporary invoice record as the invoice total. The resulting temporary invoice record comprises the data shown and described in connection with FIG. 11, comprising header information 1110 of an invoice ID 1111, hospital ID 1112, customer ID 1113 and date 1114; body information 1120 of all items for purchase including all product item IDs 1122, wholesale price 1123, snapshot data including per-item fees 1124-1126 and item totals 1127; and footer information 1130 comprising snapshot data comprising per-invoice fees 1131-1133, invoice total 1134 and invoice status 1135. As shown in FIG. 5, the entire temporary invoice record, now complete, is marked as open by setting the status field to open and is transferred as shown at 508 of FIG. 5 to the invoices database 255 for storage for later use in determining and crediting sale proceeds to the various parties to the transaction, including the veterinary hospital, the central product provider, taxing authorities and vendors as necessary and appropriate.

Payment Processing Phase

Referring now to FIG. 6, given a unique invoice ID from the selection process described above and indicating the invoice to be processed for payment, there is shown the method for processing credit card payments. At 602 the method retrieves the invoice for processing from the invoices database 255 using the invoice ID and determines whether there is an individual customer responsible for the transaction as shown at 603, by detecting whether the customer ID field in the header of the invoice record is null. If the customer ID field is null, this indicates that this is a hospital purchase, and a hospital ID is used as shown at 605 to retrieve a next hospital credit card from the wallet database 254 to fund the transaction as shown at 606. In the alternative, if the customer ID field is populated with a value, this indicates that either a point of sale customer or a web-based customer is responsible for the purchase, and in this case a customer ID is used as shown at 604 to retrieve a next customer credit card from the wallet database 254 to fund the transaction by paying the invoice total as shown at 606. The wallet database 254 contains at least one set of credit card processing information for each customer and hospital in the system.

At 606, the method accesses the wallet database 254 and returns into computer readable memory the next entire credit record for the subject payor, whether hospital or customer, and attempts processing the payment for the invoice total at 609 by accessing a third party credit card processing financial institution 620 over the Internet, phone line or other remote network connection. If the transaction is not approved 610, control is passed to decision logic 607 to determine whether there exists another credit card in the wallet database 254 for the subject payor. If no additional credit card is found, the transaction is not approved for purchase and is placed on hold, by changing the status of the invoice to hold, for administrative action as shown at 608. If another card is found at 607, control is returned again to 606 for a repeat of the steps of the method with respect to the newly found credit card for processing. If the transaction is approved at 610, payment is made, the invoice marked as paid by changing the status of the invoice to paid and the order is released to fulfillment.

Proceeds Allocation, Crediting and Distribution Phase

Referring now to FIG. 7, the method during which product sale proceeds for one or more veterinary hospitals are allocated, credited and distributed begins at 701, and wherein each at least one fee (whether it be a per-item fee or a per-invoice fee, or both) comprises a fee ID associated with a fee amount. The proceeds determination, crediting and distribution method beginning at 701 may be performed at any chosen time, whether randomly or periodically, such as daily, weekly, monthly or other period. The method continues by retrieving from the invoices database 255 into a computer-readable medium at least part of an invoice record marked as paid as indicated in the status field of the invoice record and containing the unique invoice ID, the hospital ID, the at least one fee ID and associated fee amount. To accommodate the processing of all fees in the retrieved invoice record, a loop 708, 709, 713 is employed that processes the fees sequentially until all of the fees of the invoice record have been processed. As shown at 708, each fee from the invoice record is used to find a corresponding fee record in the fees database 254 which contains a match of the hospital ID and fee ID of the invoice record in temporary memory. Upon finding the matching fee record in the fees database there is retrieved the associated hospital portion value from the hospital portion field of the matching fee record in the fees database 254. The method then determines, credits and distributes the amount to be credited to the hospital by multiplying the hospital portion value from the fees database by the fee amount from the invoice record 709. At 712, the hospital account identified by the hospital ID found in the invoice record and credited by the previously determined hospital portion of the fee amount and sufficient details, such as invoice ID, date of sale and other relevant identifying information, from the invoice, are recorded to identify the source of the credit for data processing and proceeds distribution purposes. At 713, the invoice record in computer-readable medium is checked to determine if there are any further fees in the invoice record to process in accordance with the aforementioned steps. If there are additional fees in the invoice record to process, control is transferred to the loop beginning at 708 and processing continues. When there are no more fees to process as determined at 713, the invoice status of the corresponding invoice in the invoices database 255 is marked as closed at 714 and the determination is made at 716 as to whether there is another invoice marked as paid in the invoices database to process. After the final fee of the current invoice in process is accounted for, the method checks to see if there are additional invoices to be processed at 716. If so, the steps of the method 704 through 716 are repeated for the next invoice. When there are no more invoices to process, the method is complete and exits at 720. In time, when additional invoices are stored into the invoices database 255 and marked as paid, the method is invoked again to process the new paid invoices.

Alternatively, there is provided a computer-enabled method for sale proceeds sharing with a veterinary hospital, comprising the steps of: (a) storing in a computer-readable medium a plurality of fee records, each fee record comprising at least a unique fee ID, a hospital ID and a hospital portion value; (b) retrieving into another computer-readable medium at least part of a marked-paid invoice record containing a unique invoice ID, a hospital ID and at least one fee, the at least one fee comprising a fee ID and associated fee amount; (c) for each fee from the invoice record accessing an associated fee record in the computer-readable medium having a matching hospital ID and a matching fee ID that correspond to the hospital ID of the invoice record and the fee ID of the at least one fee of the invoice record; (d) retrieving the hospital portion value of the associated fee record; (e) crediting and distributing to the hospital the product of the fee amount of the at least one fee and the hospital portion value of the associated fee record; and (f) marking the invoice as closed.

It will appreciated by those of ordinary skill in the art that the methods of crediting and distributing of funds to the hospital's account are well known in the field of electronic banking.

It will be appreciated by those of ordinary skill in the art that additional data and processes used to determine percentages of proceeds to a particular hospital could include added snapshotting of fee split information along with per-item and per-invoice fees to enable subsequent calculation and determination of hospital percentages at a contractually agreed upon time during the process.

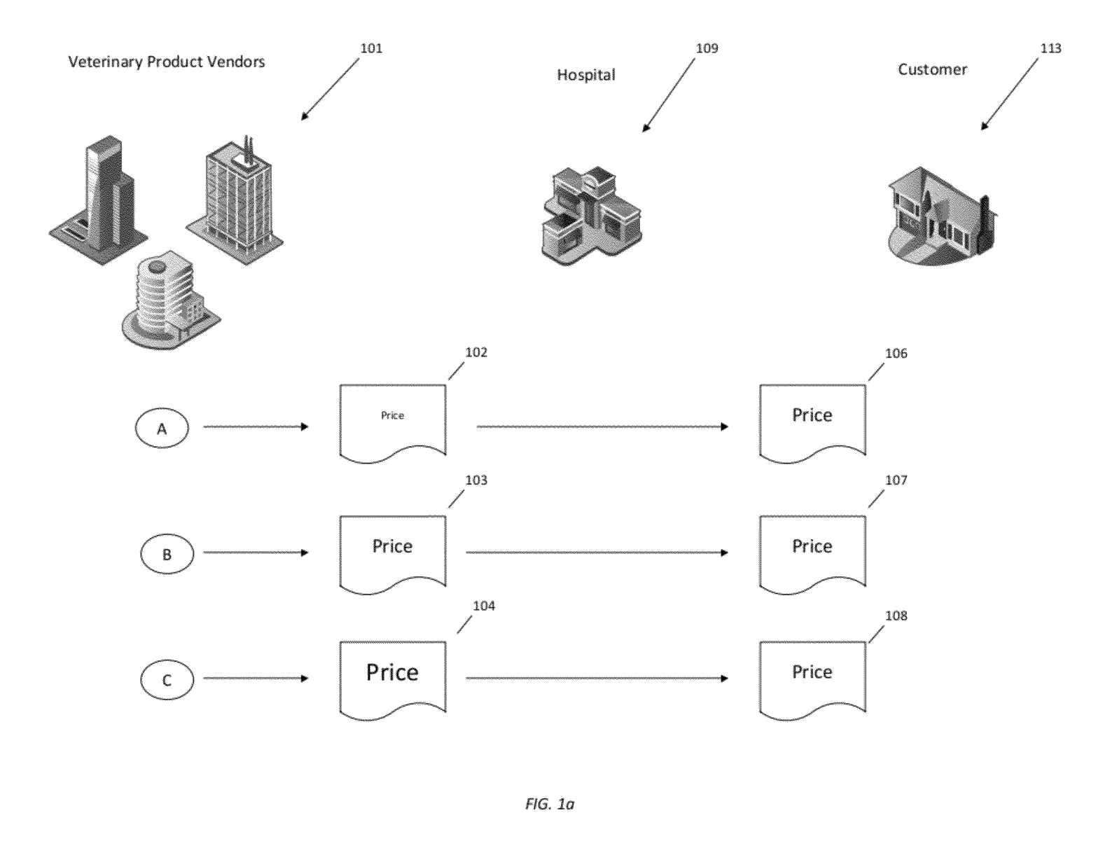

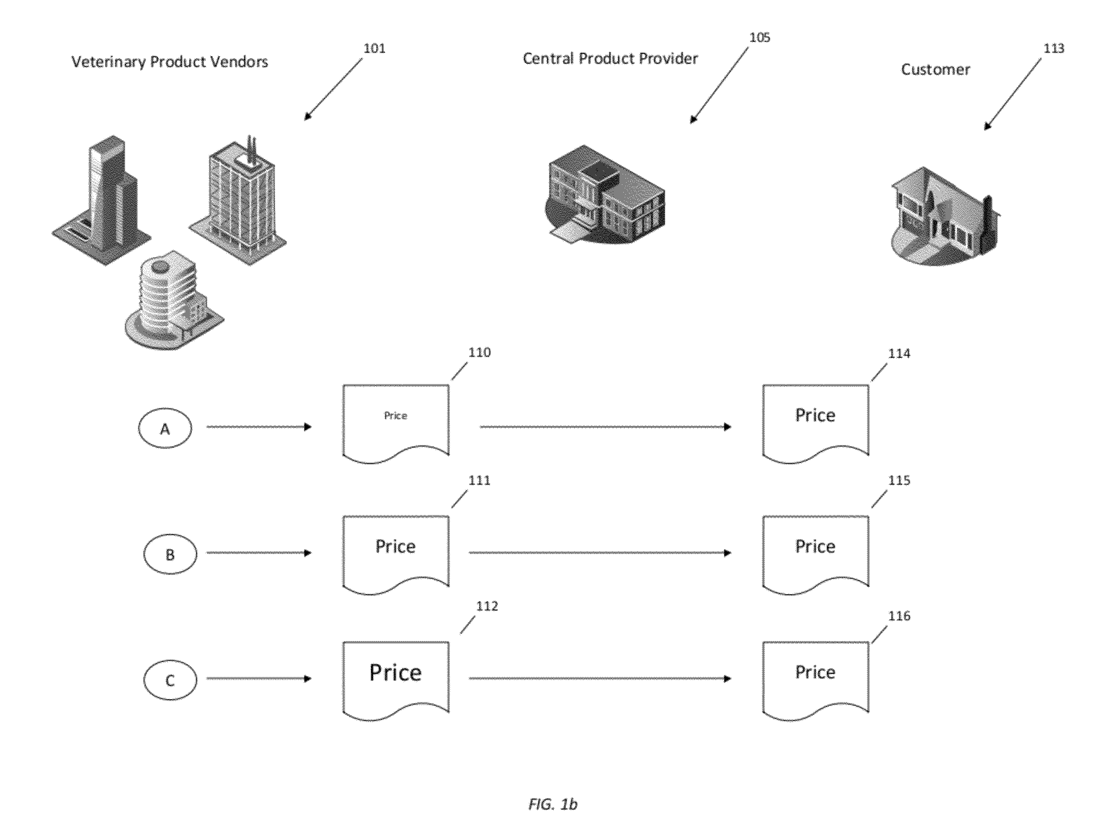

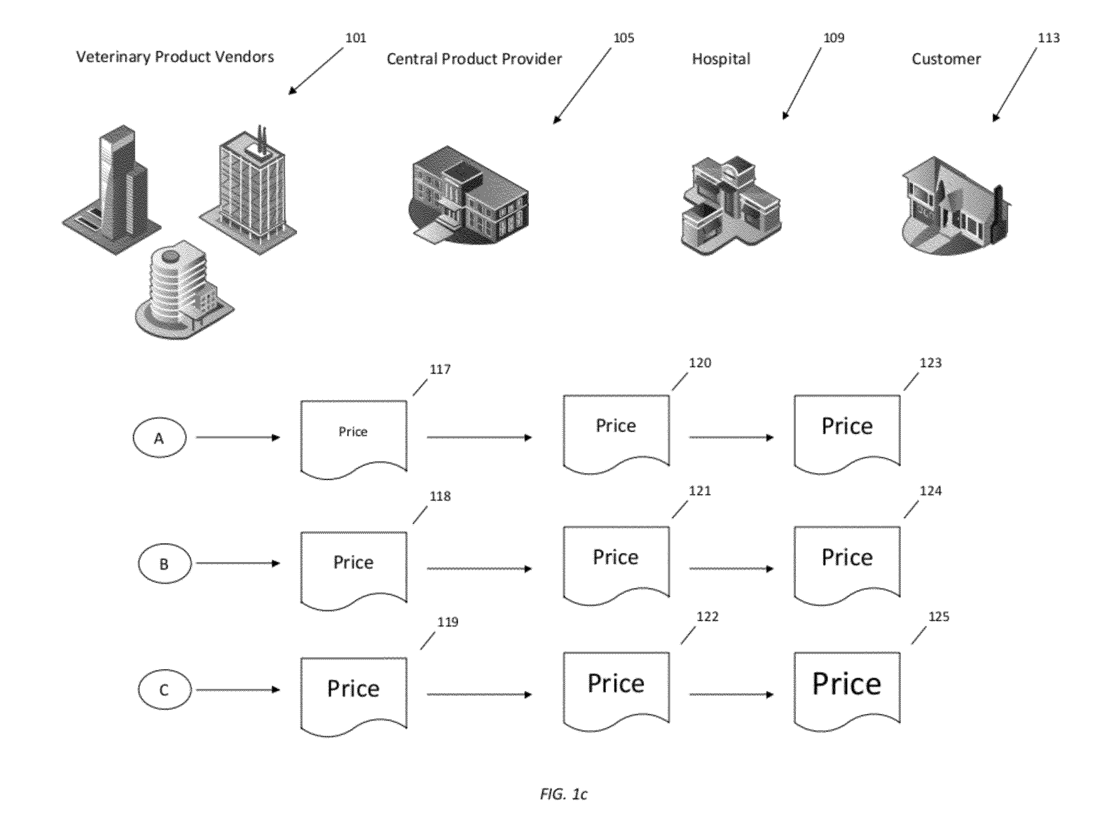

As shown in FIG. 1c, the invention places the veterinary hospital 109 in the transaction in a central-product-provider-to-hospital-to-customer relationship and thus enhances the relationship of the hospital 109 and the customer 113, which tends to enhance the care that animals receive. Further, as shown at 123, 124, 125, the hospital avoids the erosion of its profit margin since the invention enables immediate, real-time, pricing increases associated with wholesale and distribution chain price increases as shown in rows A, B and C, at 117, 120, 123; 118, 121, 124; and 119, 122, 125, respectively.

The determination, allocation and distribution of proceeds is, in accordance with the present invention is based upon real-time, immediately updated, wholesale pricing and dynamic per-item and per-invoice fee tracking. This is true whether the sale of veterinary products is to the hospital itself for use on its own account, to a hospital customer who purchases at a point of sale hospital computer terminal, or to a hospital, or veterinarian, customer who purchases at an e-commerce website hosted for the hospital by the central product provider.

This automation relieves the burden of paying vendors and taxing authorities from the backs of veterinarians and veterinary hospitals so that hospitals and veterinarians can effectively participate in the transaction and be more involved with care for animals. Further, this avoids the need of the hospital to maintain its own pharmacy, thus saving it the cost and effort associated with having to do so. This, in turn, yields better compliance with animal treatment regimens and care for animals, since involving a veterinarian in the treatment of the animal is encouraged by the invention.

It will be readily appreciated that the invention effectively accommodates support of a large number of smaller, in some cases, and disparate veterinary treatment centers by a central pharmacy/product provider—effectively enabling the central product provider to facilitate participation in the sale of animal-related products directly to veterinary hospital customers.

This aspect of the invention is primarily intended for products not requiring a prescription authorization from the veterinarian hospital, such as supplements, feeds, over-the-counter treatment regimens and the like. However, this aspect of the invention may enable a user to purchase refills of already authorized pharmaceuticals as well. For example, a veterinarian may authorize a heartworm medication for an animal that may be renewable for six months. If the customer didn't want to purchase all six months in advance, he or she could access the hospital's website through a secure account to purchase pre-authorized refill medications for which the animal has already been seen by the veterinarian.

Similarly, where a customer commits to purchase an animal product for a period of time, for example monthly for 12 months, and they want to pay monthly for the 12-month period, the system will automatically refill the order each month and charge the customer's credit card. The current sales price will be applied to each monthly transaction and will be automatically credited and distributed to the hospital.

Since, as shown in FIG. 1c, in accordance with the present invention the veterinary hospital 109 is interposed between the central product provider 105 and the customer 113, in the sale of products to the customer, the veterinarian is supported in more direct and effective treatment of the animal. As such, this coherent, comprehensive, veterinarian-centric method and system of supplying animal-related products to animal owners for administering treatments to their animals fosters appropriate and best practices for practicing veterinarian medicine.

While a preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

What is claimed is:

1) A computer-enabled method for dynamic, automated pricing of veterinary pharmaceutical and other animal-related product items by a central product provider, wherein said method allows subsequent recovery of historical pricing information by the central product provider for subsequent sale proceeds sharing with a veterinary hospital, comprising the steps of:
(a) in a central product provider computer, asynchronously creating and storing in a computer readable medium member account details for a veterinary hospital identified by a unique hospital ID;
(b) in the central product provider computer, asynchronously maintaining and storing in a computer-readable medium a plurality of per-item fee records, each fee record comprising at least a unique per-item fee ID, a product item ID, a fee amount, a hospital ID, a pharmacy portion designation and a veterinary hospital portion designation;
(c) in the central product provider computer, asynchronously retrieving and storing in a computer readable medium information for a plurality of product item records, each product item record being given at least a unique product item record ID and a current base price, each product item record being received from at least one networked vendor computer;
(d) responsive to a request from a veterinary hospital computer, in a central product provider computer, creating in computer readable memory a temporary invoice record comprising a unique invoice ID, temporarily storing in the invoice record the veterinary hospital ID of the hospital making the request and providing to the veterinary hospital computer item product information for at least one item for selection;
(e) responsive to a selection from the veterinary hospital computer, in the central product provider computer, temporarily storing in the invoice record a snapshot for subsequent optional recall of product item record information comprising at least a unique product item ID, current base price corresponding to the selected product item, at least one per-item fee corresponding to the selected product item, the at least one per-item fee comprising a fee ID and a per-item fee amount, and a selected product item price total comprising the sum of the product item current base price and the at least one per-item fee amount; and
(f) making available for display at the veterinary hospital computer the selected item product information and the corresponding total selected product item price.

2) The method of claim 1, wherein the central product provider computer-readable medium further comprises storage for at least one per-invoice fee, each per-invoice fee comprising a per-invoice fee ID and a per-invoice fee amount, further comprising the steps of:
(a) in the central product provider computer, responsive to a confirmation of an intention to purchase the at least one item temporarily stored in the temporary invoice record, retrieving and storing in the invoice record at least one per-invoice fee comprising a fee ID and an associated fee amount;
(b) calculating and storing in the invoice record an invoice total comprising each product item price total and the at least one per-invoice fee; and
(c) marking the invoice record as open and transferring the invoice record to an invoices database.

3) The method of claim 1, wherein the at least one per-item fee comprises at least one of the following fees: handling fee, pharmacy fee, nutrition fee, item cover fee, wholesale sales tax and distribution fee.

4) The method of claim 1, wherein said steps of the method are repeated for each item product selected for inclusion on the invoice, the method creating an item record temporarily stored in the temporary invoice record for each iteration of the steps of the method.

5) The method of claim 2, wherein the unique hospital ID references a wallet database with at least one set of credit card processing information for the hospital, and further comprising the steps of processing payment of the invoice total using the at least one set of credit card processing information, obtaining approval from the credit card financial institution, marking the invoice as paid.

6) The method of claim 2, wherein said at least one per-invoice fee comprises at least one of the following fees: credit card processing fee, shipping fee and applicable federal, state and local taxes.

7) The method of claim 1, wherein the central product provider computer comprises a plurality of networked computers.

8) A computer-enabled method for dynamic, automated pricing of veterinary pharmaceutical and other animal-related product items by a central product provider, wherein said method allows subsequent recovery of historical pricing information by the central product provider for subsequent sale proceeds sharing with a veterinary hospital, comprising the steps of:
(a) in a central product provider computer, asynchronously creating and storing in a computer readable medium member account details for a veterinary hospital identified by a unique hospital ID;
(b) in the central product provider computer, asynchronously maintaining and storing in a computer-readable medium a plurality of per-item fee records, each fee record comprising at least a unique per-item fee ID, a product item ID, a fee amount, a hospital ID, a pharmacy portion designation and a veterinary hospital portion designation;
(c) in the central product provider computer, asynchronously retrieving and storing in a computer readable medium information for a plurality of product item records, each product item record being given at least a unique product item record ID and a current base price, each product item record being received from at least one networked vendor computer;
(d) responsive to a request from a veterinary hospital computer, in a central product provider computer, creating in computer readable memory a temporary invoice record comprising a unique invoice ID, temporarily storing in the invoice record the veterinary hospital ID of the hospital making the request and providing to the veterinary hospital computer item product information for at least one item for selection;
(e) responsive to a selection from the veterinary hospital computer, in the central product provider computer, temporarily storing in the invoice record a snapshot for subsequent optional recall of product item record information comprising at least a unique product item ID, current base price corresponding to the selected product item, at least one per-item fee corresponding to the selected product item, the at least one per-item fee comprising a fee ID and a per-item fee amount, and a selected product item price total comprising the sum of the product item current base price and the at least one per-item fee amount; and
(f) making available for display at the veterinary hospital computer the selected item product information and the corresponding the total selected product item price.

9) The method of claim 8, wherein the central product provider computer-readable medium further comprises storage for at least one per-invoice fee, each per-invoice fee comprising a per-invoice fee ID and a per-invoice fee amount, further comprising the steps of:
(a) in the central product provider computer, asynchronously creating and storing in a computer readable medium member account details for a veterinary hospital customer identified by a unique customer ID;
(b) in the central product provider computer, responsive to a confirmation of an intention to purchase the at least one item temporarily stored in the temporary invoice record, retrieving and storing in the invoice record at least one per-invoice fee comprising a fee ID and an associated fee amount;
(c) calculating and storing in the invoice record an invoice total comprising each product item price total and the at least one per-invoice fee; and
(d) marking the invoice record as open and transferring the invoice record to an invoices database.

10) The method of claim 8, wherein the at least one per-item fee comprises at least one of the following fees: handling fee, pharmacy fee, nutrition fee, item cover fee, wholesale sales tax and distribution fee.

11) The method of claim 8, wherein said steps of the method are repeated for each item product selected for inclusion on the invoice, the method creating an item record temporarily stored in the temporary invoice record for each iteration of the steps of the method.

12) The method of claim 9, wherein the unique customer ID references a wallet database with at least one set of credit card processing information for the customer, and further comprising the steps of processing payment of the invoice total using the at least one set of credit card processing information, obtaining approval from the credit card financial institution, marking the invoice as paid.

13) The method of claim 9, wherein the at least one per-invoice fee comprises at least one of the following fees: credit card processing fee, shipping fee and applicable federal, state and local taxes.

14) The method of claim 8, wherein the central product provider computer comprises a plurality of networked computers.

15) A computer-enabled method for dynamic, automated pricing of veterinary pharmaceutical and other animal-related product items by a central product provider, wherein said method allows subsequent recovery of historical pricing information by the central product provider for subsequent sale proceeds sharing with a veterinary hospital, comprising the steps of:
(a) hosting a website for a veterinary hospital at a central product provider computer;
(b) in the central product provider computer, asynchronously creating and storing in a computer readable medium member account details for a veterinary hospital identified by a unique hospital ID;
(c) in the central product provider computer, asynchronously creating and storing in a computer readable medium member account details for a veterinary hospital customer identified by a unique customer ID;
(d) in the central product provider computer, asynchronously maintaining and storing in a computer-readable medium a plurality of per-item fee records, each fee record comprising at least a unique per-item fee ID, a product item ID, a fee amount, a hospital ID, a pharmacy portion designation and a veterinary hospital portion designation;
(e) in a central product provider computer, asynchronously retrieving and storing in a computer readable medium information for a plurality of product item records, each product item record being given at least a unique product item record ID and a current base price, each product item record being received from at least one networked vendor computer;
(f) responsive to a request from a hospital customer via the hosted website, in a central product provider computer, creating in computer readable memory a temporary invoice record comprising a unique invoice ID, temporarily storing in the invoice record the veterinary hospital ID of the hospital making the request and providing to the veterinary hospital computer item product information for at least one item for selection;
(g) responsive to a selection from the veterinary hospital customer via the hosted website, in the central product provider computer, temporarily storing in the invoice record a snapshot for subsequent optional recall of product item record information comprising at least a unique product item ID, current base price corresponding to the selected product item, at least one per-item fee corresponding to the selected product item, the at least one per-item fee comprising a fee ID and a per-item fee amount, and a selected product item price total comprising the sum of the product item current base price and the at least one per-item fee amount; and
(h) making available for display to the veterinary hospital customer via the hosted website the selected item product information and the corresponding total selected product item price.

16) The method of claim 15, wherein the central product provider computer-readable medium further comprises storage for at least one per-invoice fee, each per-invoice fee comprising a per-invoice fee ID and a per-invoice fee amount, further comprising the steps of:
(a) in the central product provider computer, responsive to a confirmation by the hospital customer of an intention to purchase the at least one item temporarily stored in the temporary invoice record, retrieving and storing in the invoice record at least one per-invoice fee comprising a fee ID and an associated fee amount;
(b) calculating and storing in the invoice record an invoice total comprising each product item price total and the at least one per-invoice fee; and
(c) marking the invoice record as open and transferring the invoice record to an invoices database.

17) The method of claim 15, wherein the at least one per-item fee comprises at least one of the following fees: handling fee, pharmacy fee, nutrition fee, item cover fee, wholesale sales tax and distribution fee.

18) The method of claim 15, wherein the steps of the method are repeated for each item product selected for inclusion on the invoice, the method creating an item record temporarily stored in the temporary invoice record for each iteration of the steps of the method.

19) The method of claim 16, wherein the unique customer ID references a wallet database with at least one set of credit card processing information for the customer, and further comprising the steps of processing payment of the invoice total using the at least one set of credit card processing information, obtaining approval from the credit card financial institution, marking the invoice as paid.

20) The method of claim 16, wherein the at least one per-invoice fee comprises at least one of the following fees: credit card processing fee, shipping fee and applicable federal, state and local taxes.

21) The method of claim 15, wherein the central product provider computer comprises a plurality of networked computers.

22) The method of claim 5, wherein each at least one fee comprises a fee ID associated with a fee amount, and wherein product sale proceeds for the hospital are allocated, credited and distributed, further comprising the steps of:
(a) retrieving into a computer-readable medium at least part of a marked paid invoice record containing the unique invoice ID, the unique hospital ID and the at least one fee ID and associated fee amount;
(b) for each fee ID from the invoice record accessing an associated fee record in accordance with a match of the hospital ID and fee ID of the invoice record with hospital ID and fee ID fields of the fees database to obtain an associated hospital portion value from the hospital portion field of the fees database;
(c) crediting and distributing to the hospital the product of the associated fee amount and the hospital portion value; and
(d) marking the invoice as closed.

23) The method of claim 12, wherein each at least one fee comprises a fee ID associated with a fee amount, and wherein product sale proceeds for the hospital are allocated, credited and distributed further comprising the steps of:
(a) retrieving into a computer-readable medium at least part of a marked paid invoice record containing the unique invoice ID, the unique hospital ID and the at least one fee ID and associated fee amount;
(b) for each fee ID from the invoice record accessing an associated fee record in accordance with a match of the hospital ID and fee ID of the invoice record with hospital ID and fee ID fields of the fees database to obtain an associated hospital portion value from the hospital portion field of the fees database;
(c) crediting and distributing to the hospital the product of the associated fee amount and the hospital portion value; and
(d) marking the invoice as closed.

24) The method of claim 19, wherein each at least one fee comprises a fee ID associated with a fee amount, and wherein product sale proceeds for the hospital are allocated, credited and distributed further comprising the steps of:
(a) retrieving into a computer-readable medium at least part of a marked paid invoice record containing the unique invoice ID, the unique hospital ID and the at least one fee ID and associated fee amount;
(b) for each fee ID from the invoice record accessing an associated fee record in accordance with a match of the hospital ID and fee ID of the invoice record with hospital ID and fee ID fields of the fees database to obtain an associated hospital portion value from the hospital portion field of the fees database;
(c) crediting and distributing to the hospital the product of the associated fee amount and the hospital portion value; and
(d) marking the invoice as closed.

25) A computer-enabled method for sale proceeds sharing with a veterinary hospital, comprising the steps of:
(a) storing in a computer-readable medium a plurality of fee records, each fee record comprising at least a unique fee ID, a hospital ID and a hospital portion value;
(b) retrieving into another computer-readable medium at least part of a marked-paid invoice record containing a unique invoice ID, a hospital ID and at least one fee, the at least one fee comprising a fee ID and associated fee amount;
(c) for each fee from the invoice record accessing an associated fee record in the computer-readable medium having a matching hospital ID and a matching fee ID that correspond to the hospital ID of the invoice record and the fee ID of the at least one fee of the invoice record;
(d) retrieving the hospital portion value of the associated fee record;
(e) crediting and distributing to the hospital the product of the fee amount of the at least one fee and the hospital portion value of the associated fee record; and
(f) marking the invoice as closed.
